(19) United States
(12) Patent Application Publication
(10) Pub. No.: US 2020/0321604 A1
(43) Pub. Date: Oct. 8, 2020

(54) SINTERED ELECTRODE CELLS FOR HIGH ENERGY DENSITY BATTERIES AND RELATED METHODS THEREOF

(71) Applicant: University of Virginia Patent Foundation, Charlottesville, VA (US)

(72) Inventors: Gary M. Koenig, Jr., Charlottesville, VA (US); James Pierce Robinson, Houston, TX (US)

(73) Assignee: University of Virginia Patent Foundation, Charlottesville, VA (US)

(21) Appl. No.: 16/754,920

(22) PCT Filed: Nov. 1, 2018
(86) PCT No.: PCT/US2018/058710

§ 371 Date: Apr. 9, 2020

Related U.S. Application Data
(60) Provisional application No. 62/580,175, filed on Nov. 1, 2017.
(60) Provisional application No. 62/658,076, filed on Apr. 16, 2018.
(60) Provisional application No. 62/752,669, filed on Oct. 30, 2018.

(51) Int. Cl. H01M 4/04; H01M 2/16; H01M 4/62; H01M 4/505; H01M 4/525; H01M 10/0525; H01M 4/38

(52) U.S. Cl. CPC H01M 4/0471; H01M 2/1673; H01M 4/623; H01M 4/505; H01M 2004/021; H01M 4/045; H01M 10/0525; H01M 4/625; H01M 4/382; H01M 4/525

(57) ABSTRACT

An electrochemical device that includes an anode electrode having sintered active material, in electronic communication with an anode current collector. The device includes a cathode electrode having sintered active material, in electronic communication with a cathode current collector. The device also includes a separator located between the anode electrode and the cathode electrode, and further includes an electrolyte in ionic contact with the anode electrode, cathode electrode, and separator, thereby filling porous spaces within the anode electrode and cathode electrode. The electrochemical device provides for the ability of increasing the energy density at the electrode and cell level and provides for reducing the size and weight of battery cells and packs. Such energy density improvements can be accomplished through increasing active material density in electrodes by decreasing porosity and removing inactive additives, as well as by using thicker electrodes that reduce the relative fraction of separators and current collectors in the cell.

### RELATED APPLICATIONS

The present application claims benefit of priority under 35 U.S.0 § 119 (e) from U.S. Provisional Application Ser. No. 62/580,175, filed Nov. 1, 2017, entitled “High Energy Lithium-Ion Batteries with Thick Electrodes and Related Method Thereof”, U.S. Provisional Application Ser. No. 62/658,076, filed Apr. 16, 2018, entitled “High Energy Lithium-Ion Batteries with Thick Electrodes and Related Method Thereof”, and U.S. Provisional Application Ser. No. 62/752,669, filed Oct. 30, 2018, entitled “High Energy Lithium-Ion Batteries with Thick Electrodes and Related Method Thereof”; all of the disclosures of which are hereby incorporated by reference herein in their entirety.

### STATEMENT OF GOVERNMENT INTEREST

This invention was made with government support under Grant No. 1652488, awarded by the The National Science Foundation. The government has certain rights in the invention.

### FIELD OF INVENTION

The present disclosure relates generally to electrochemical device architectures. More particularly, the present disclosure relates to battery cells that include sintered active materials for the anode electrode and cathode electrode and the related methods of manufacturing and using the same.

### BACKGROUND

Continued growth in the number of battery-powered devices such as portable electronics and electric vehicles demands the development of higher energy density batteries, with lithium-ion (Li-ion) batteries still the dominant choice for these rechargeable applications.[1] While development of new Li-ion materials chemistry is one approach to increase cell energy density,[2, 3] substantial improvements in energy density can also be achieved by using established materials through improved engineering of the battery electrodes.[4, 5]

Designing electrodes for high total energy or energy density often results in compromises in the rate capability of the electrode. Removal of conductive additives and binders in composite electrodes will reduce the electrode electronic conductivity and mechanical integrity, respectively.[6, 7] Calendaring is a process often done to improve electronic conductivity and increase the volumetric energy density of a composite electrode, but this step reduces the volume of the electrode allocated to the electrolyte, creating restrictions in Li⁺ transport.[8, 9] Also, thick and dense electrodes can be difficult to manufacture without cracking or delamination.[10] Large particles, which pack well into composite electrodes, have longer internal diffusion paths and lower surface areas for intercalation reactions which limits rate capability of the battery cell.[11, 12] The combination of the factors described above leads to common processing and design limits for composite electrodes, and most composite electrodes reported for Li-ion batteries have thicknesses below 250 μm and active material volume fractions below 60%.[2, 13, 14]

### SUMMARY OF EXEMPLARY EMBODIMENTS OF THE INVENTION

An aspect of an embodiment provides for, among other things, higher energy density electrodes that can be accomplished by increasing the volume fraction of active material via higher packing densities, removing inactive additives, and/or increasing electrode thicknesses.

An aspect of an embodiment provides for the ability of increasing the energy density of lithium-ion batteries at the electrode and cell level and also to continue reducing the size and weight of battery cells and packs. Energy density improvements can be accomplished through increasing active material density in electrodes by decreasing porosity and removing inactive additives, as well as by using thicker electrodes that reduce the relative fraction of separators and current collectors in the cell. An aspect of an embodiment of the present invention provides, among other things, the fabrication of sintered electrodes comprised of only electro-active material toward the goal of thick electrodes free of binders and conductive additives. An aspect an embodiment provides, but not limited thereto, full Li₄Ti₅O₁₂/LiCoO₂ (LTO/LCO) sintered electrode cells with total combined thickness of anode, separator, and cathode of up to 2.90mm have been successfully fabricated and electrochemically evaluated. These cells have improved stability and high areal capacities, as high as 45 mAh cm⁻² capacity at 1.28 mA cm⁻².

An aspect of an embodiment of the present invention provides, among other things, higher energy density by having both the anode electrode and cathode electrode be sintered porous electrodes which results in drastic improvements in cycling stability.

An aspect of an embodiment of the present invention provides for, among other things, the reduction in the amount of inactive material or dead weight/volume in the battery cell.

An aspect of an embodiment of the present invention provides, among other things, sintered electrode cells for high energy density lithium-ion batteries, and related method of manufacturing and using the same.

An aspect of an embodiment of the present invention provides, among other things, sintered electrode cells for high energy density sodium-ion batteries, and related method of manufacturing and using the same.

An aspect of an embodiment of the present invention provides, among other things, sintered electrode cells for high energy density potassium-ion batteries, and related method of manufacturing and using the same.

An electrochemical device according to one embodiment of the present invention is schematically depicted in FIG. 1. The electrochemical device 11 can be an energy storage system having a anode 13 and cathode 15 that are spaced apart from each other by a separator 23 (e.g., spacer region), and an electrolyte 17 (not shown) may be disposed in the porous regions of the anode 13 and cathode 15 and separator 23. Also shown is collector structure 29 wherein said anode 13 is disposed thereon, as well as another collector structure 31 wherein said cathode 15 is disposed thereon. Optionally, as shown in FIG. 2, a buffer structure 33 may be disposed between the anode 13 and collector structure 29, as well as another buffer structure 35 that may be disposed between the cathode 15 and collector structure 31. In an embodiment, rather than a buffer structure, the material pellets can be buried or disposed in the current collector.

The lithium battery can be charged (for example a power supply or power source 25) by applying a voltage between the electrodes 13 and 15, which causes lithium ions 18 and electrons to be withdrawn from the battery's cathode 15. Lithium ions 18 flow from cathode 15 to anode 13 through electrolyte 17 (not shown) to be reduced at the anode 13. During discharge, the reverse occurs; lithium ions 18 and electrons enter at cathode 15 while the anode 13 is oxidized and lithium ions leave the anode 13, which is typically an energetically favorable process that drives electrons through an external circuit 19, thereby supplying electrical power to a device to which the battery is connected. If sodium (Na) or potassium (K) metal is used instead Lithium (Li) metal then the cation charge carrier in the electrolyte would change to Na or K (rather than Li as the cation charge carrier used with the Li metal and/or lithium-ion electrodes).

Thus, during battery operation, for example, lithium ions pass through several steps to complete the electrochemical reaction. Typically, the steps include release of lithium at the anode surface, which typically releases an electron to the external circuit; transport of the lithium ions through the electrolyte (which can reside in pores of a separator and, with porous electrodes, in the electrodes' pores); transport of the lithium ions through the electrolyte phase in a cathode; intercalation of lithium into the active cathode material, which typically receives electrons from the external circuit; and diffusion of lithium ions into the active material.

The charging may be provided by a variety of energy, power supply or power sources. For example, such power or energy supply may be provided by, but not limited thereto, any one or more of the following: AC current, DC current, solar energy, wind energy, geothermal energy, hydrogen energy, tidal energy, wave energy, hydroelectricity energy, biomass energy, nuclear power, fossil fuels (coal, oil, natural gas), or piezo electric devices, circuits, or systems.

The charging may be provided by a variety of energy, power supply or power sources. For example, inductive charging (e.g., using electromagnetic induction to charge the battery), motion-power charging (e.g., charge the battery based on motion, such as human or animal motion or inanimate object motion such as a robot or other structure, apparatus or mechanism).

The charging may be provided by induction-powered charging, such as an electric transport system (called online Electric Vehicle, OLEV) where the vehicles get their power needs from cables underneath the surface of the road via inductive charging, (where a power source is placed underneath the road surface and power is wirelessly picked up on the vehicle itself). Similarly, rather than a road it may be applied to floors, aircraft runways, other surfaces, other facilities, or architectural structures.

Moreover, it should be appreciated that any of the components or modules referred to with regards to any of the present invention embodiments discussed herein, may be integrally or separately formed with one another. Further, redundant functions or structures of the components or modules may be implemented. Moreover, the various components may be communicated locally and/or remotely with any user or machine/system/computer/processor. Moreover, the various components may be in communication via wireless and/or hardwire or other desirable and available communication means, systems and hardware. Moreover, various components and modules may be substituted with other modules or components that provide similar functions.

It should be appreciated that the device and related components discussed herein may take on all shapes along the entire continual geometric spectrum of manipulation of x, y and z planes to provide and meet the environmental, anatomical, and structural demands and operational requirements. Moreover, locations and alignments of the various components may vary as desired or required.

It should be appreciated that various sizes, dimensions, contours, rigidity, shapes, flexibility and materials of any of the components or portions of components in the various embodiments discussed throughout may be varied and utilized as desired or required.

It should be appreciated that while some dimensions are provided on the aforementioned figures, the device may constitute various sizes, dimensions, contours, rigidity, shapes, flexibility and materials as it pertains to the components or portions of components of the device, and therefore may be varied and utilized as desired or required.

Although example embodiments of the present disclosure are explained in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified. Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the nt^{h} reference in the list. All references cited and discussed in this specification are incorporated herein by reference in their entireties and to the same extent as if each reference was individually incorporated by reference.

It should be appreciated that as discussed herein, a subject may be a human or any animal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to human (e.g. rat, dog, pig, monkey), etc. It should be appreciated that the subject may be any applicable human patient, for example.

As discussed herein, a “subject” may be any applicable human, animal, or other organism, living or dead, or other biological or molecular structure or chemical environment, and may relate to particular components of the subject, for instance specific tissues or fluids of a subject (e.g., human tissue in a particular area of the body of a living subject), which may be in a particular location of the subject, referred to herein as an “area of interest” or a “region of interest.”

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g. 1 to 5includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

These and other objects, along with advantages and features of various aspects of embodiments of the invention disclosed herein, will be made more apparent from the description, drawings and claims that follow.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings.

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 schematically illustrates an embodiment of an electrochemical device in communication with an external circuit.

FIG. 2 schematically illustrates an embodiment of an electrochemical device in communication with an external circuit.

FIG. 3 graphically illustrates voltage profiles during charge/discharge for the 2^{nd} cycle of sintered electrode (solid lines) and composite electrode (dashed lines) Li/LCO cells plotted on a gravimetric basis considering just the active material (as shown in FIG. 3A) and areal basis (as shown in FIG. 3B). Areal current densities were 1.15 mA cm⁻² for the sintered electrode and 0.028 mA cm⁻² for the composite electrode, which for both cells corresponded to a rate of C./20 using a mass of active material basis.

FIG. 4 graphically illustrates capacity retention during charge/discharge cycling of Li/LCO and Li/LTO cells (for FIGS. 4A and 4B, respectively) containing sintered electrodes and capacity retention during charge/discharge cycling of a Li/Li symmetric cell (for FIG. 4C). The cells in FIGS. 4A and 4B were cycled at rates corresponding to C./20 based on active material mass (areal current densities of 1.15 mA cm⁻² for LCO, 1.10 mA cm⁻² for LTO), while the cell in FIG. 4C was cycled using a 50 hour cutoff for each charge/discharge at a rate of 0.53 mA cm⁻², which corresponded to a rate of C./50 for the sintered electrodes. Lithium metal mass for gravimetric basis in FIG. 4C corresponded to the mass of two layers of 100 μm lithium foil.

FIG. 5 graphically illustrates voltage profiles for the 2^{nd} charge/discharge cycle at C/20 (for FIGS. 5A and 5C) and rate capability of LTO/LCO cells (for FIGS. 5B and 5D) where both the LTO and LCO were sintered electrodes. The cell in FIGS. 5A and 5B contained a total anode, separator, and cathode thickness of 1.21mm, while the cell in FIGS. 5C and 5D contained a total anode, separator, and cathode thickness of 2.90mm. The profile in FIG. 5A had a voltage window of 1 to 2.8 V and areal current density of 1.15 mA cm⁻², while the cell in FIG. 5C had a voltage window of 1.5 to 3.0 V and areal current density of 1.36 mA cm⁻².

FIG. 6 illustrates SEM micrographic depictions of LiCoO₂ (LCO) and Li₄Ti₅O₁₂ (LTO) sintered electrode surfaces (as shown in FIGS. 6A and 6B, respectively). FIG. 6 illustrates cross-sectional SEM micrographic depictions at lower magnification showing the full electrode thickness LiCoO₂ (LCO) and Li₄Ti₅O₁₂ (LTO) (as shown in FIGS. 6C and 6D, respectively).

FIG. 7 graphically illustrates Voltage profiles during charge/discharge for the 1^{st} cycle of sintered electrode (solid lines) and composite electrode (dashed lines) Li/LTO cells plotted on a gravimetric basis considering just the active material (as shown in FIG. 7A) and areal basis (as shown in FIG. 7B). Areal current densities were 1.10 mA cm⁻² for the sintered electrode and 0.059 mA cm⁻² for the composite electrode, which for both cells corresponded to a rate of C./20 using a mass of active material basis.

FIG. 8 graphically illustrates the voltage profile for the 2^{nd} charge/discharge cycle of a Li/Li symmetric cell cycled at 0.53 mA cm⁻² within a voltage limit of −1.0 V to 1.0 V and with a time limit of 50 hours.

FIG. 9 graphically illustrates the rate capability test followed by extended cycling at C./20 of LTO/LCO sintered electrode cell with total anode, separator, and cathode thickness of 1.21mm cycled within a voltage window of 1.0 V to 2.8 V. The testing profile was 5 cycles at C./20, 5 cycles at C./10, 5 cycles at C./5, 5 cycles at C./50, and 180 cycles at C./20 for 200 cycles in total. The cell was the same as that used for FIG. 5A, 5B discussed herein.

FIG. 10 graphically illustrates charge/discharge profiles for LiNi_{1/3}Mn_{1/3}Ni_{1/3}O₂ (NMC) sintered electrode cathode paired with a Li metal anode in a 2032-type coin cell for the second charge/discharge cycle.

FIG. 11 graphically illustrates rate capability testing on a 2032-type coin cell where both electrodes are sintered all active material electrodes with LTO anode and LCO cathode.

FIG. 12 graphically illustrates rate capability testing on a 2032-type coin cell followed by cycle life testing where both electrodes are sintered all active material electrodes with LTO anode and LCO cathode.

FIG. 13 graphically illustrates charge/discharge voltage profiles for the same cell from FIG. 12 from cycle number 3 (solid line), 53 (dashed line), 153 (dotted line), and 203 (short dash-long dash line).

FIG. 14 graphically illustrates charge/discharge profiles on: a mass of LCO basis (as shown in FIG. 14A); a total capacity basis (as shown in FIG. 14B); and an areal capacity basis (as shown in FIG. 14C) after 7 months of storage for an LTO/LCO cell where both the anode and cathode were porous sintered electrodes.

FIG. 15 schematically illustrates an exploded view of an embodiment of an electrochemical device in communication with an external circuit.

FIG. 16 schematically illustrates a partial side view and partial cross-section view of an embodiment of an electrochemical device of the button cell or coin cell type.

FIG. 17 schematically illustrates an exploded view of an embodiment of an electrochemical device in communication with an external circuit.

FIGS. 18A-18B provide a flowchart of manufacturing an embodiment of an electrochemical device.

FIG. 19 provides a flowchart of manufacturing an embodiment of an electrochemical device.

FIG. 20 provides a flowchart of manufacturing an embodiment of an electrochemical device.

### DETEAILED DESCRIPTION OF THE INVENTION

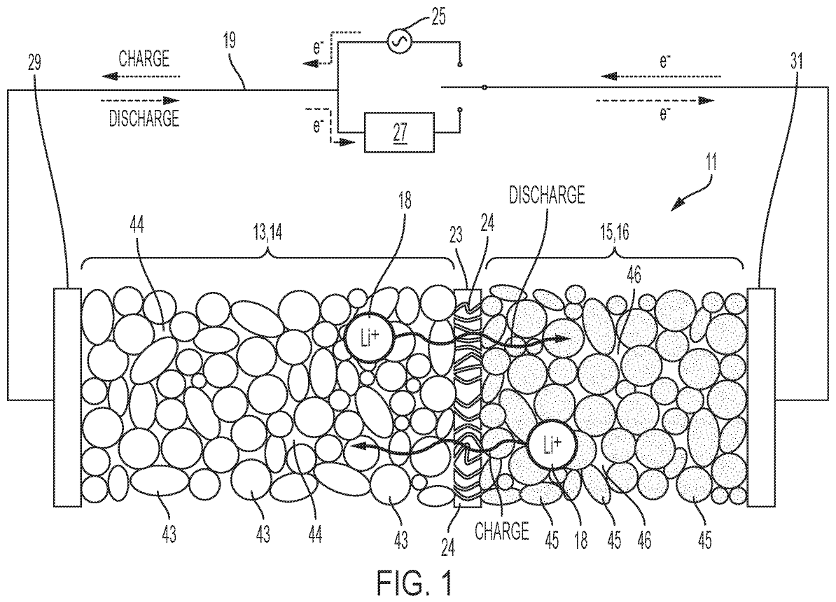

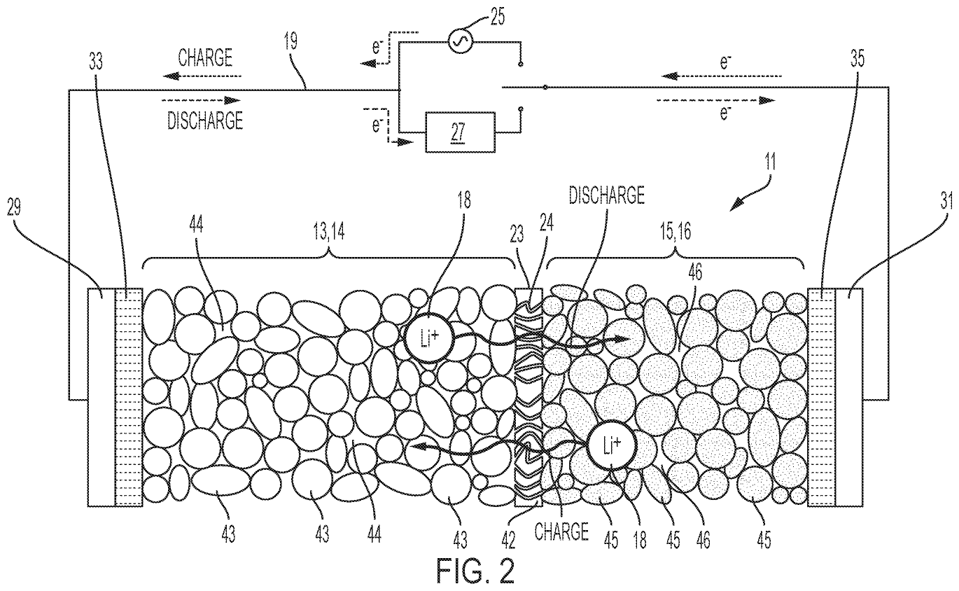

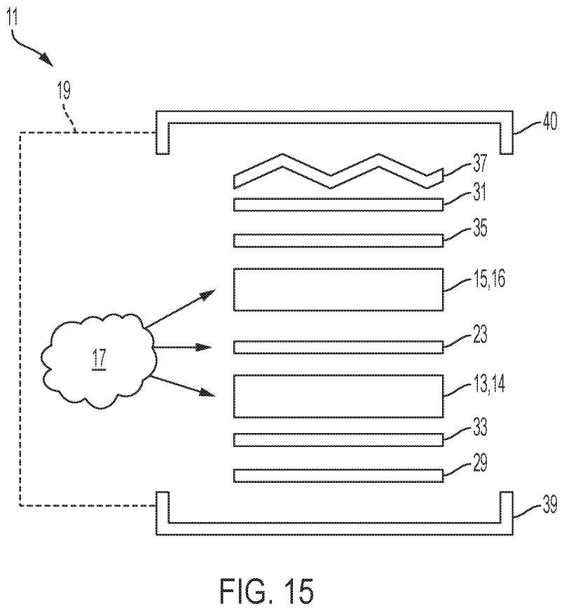

FIG. 1 schematically illustrates an embodiment of an electrochemical device 11 in communication with an external circuit 19. FIG. 2 schematically illustrates an embodiment of an electrochemical device 11 in communication with an external circuit 19 that may be similar to FIG. 1, but also includes a buffer structure 33, 35. FIG. 15 schematically illustrates an exploded view of an embodiment of an electrochemical device 11 in communication with an external circuit 19.

Still referring to FIG. 1, FIG. 2, and FIG. 15, wherein each figure provides an embodiment of the electrochemical device 11 in communication with an external circuit 19. An anode electrode 13 comprised of porous spaces 44 and only sintered active material 14 that includes particles 43. The anode 13 is in electronic communication with an anode current collector 29. A cathode electrode 15 comprised of porous spaces 46 and only sintered active material 16 that includes particles 45. The cathode 15 is in electronic communication with a cathode current collector 31. A separator 23 comprised of channels 24 is disposed between said anode electrode 13 and said cathode electrode 15. An electrolyte 17 is in ionic contact with said anode electrode 13, said cathode electrode 15, and said separator 23, and which also fills said porous spaces within the anode electrode and cathode electrode. A cap, base, or can 39 or the like and case or cap 40 may be provided to enclose the device.

In an embodiment, the electrolyte 17 fills or is dispersed into the channels 24 (passages or pores) of the separator 23 providing the ionic contact.

In an embodiment, during the manufacturing or importing of the device the electrolyte may be delayed from being provided in the earlier steps of assembly. Such that near the end or completion of the assembly device, the electrolyte is injected or dispersed into the device and followed by sealing the cell.

In an embodiment, the anode electrode and cathode electrode may each respectively be comprised of 100 percent (on a weight basis) of sintered active material, active material, and/or sintered material.

In an embodiment, the anode electrode or cathode electrode may respectively be comprised of 100 percent (on a weight basis) of sintered active material, active material, and/or sintered material.

In an embodiment, the anode electrode and/or cathode electrode may each respectively be comprised of at least substantially sintered active material, substantially active material, and/or at least substantially sintered material. At least substantially active material can be defined by a range such as anyone of the following: about 100 percent active material on a weight basis; about 98 percent active material on a weight basis; about 90 to 100 (or any fractions there between) percent active material on a weight basis; about 95 to about 100 percent active material on a weight basis; about 92 to about 98 percent active material on a weight basis; about 94 to about 96 percent active material on a weight basis; about 98 percent to about 100 active material on a weight basis; or about 90, 91, 92, 93, 94, 95, 96, 97, 98, or 99 (or any fractions there between) percent active material on a weight basis. At least substantially sintered material can be defined by a range such as anyone of the following: about 100 percent sintered material on a weight basis; about 98 percent sintered material on a weight basis; about 90 to 100 (or any fractions there between) percent sintered material; about 95 to about 100 percent sintered material on a weight basis; about 92 to about 98 percent sintered material on a weight basis; about 94 to about 96 percent sintered material on a weight basis; about 98 percent to about 100 sintered material; or about 90, 91, 92, 93, 94, 95, 96, 97, 98, or 99 (or any fractions there between) sintered material on a weight basis. At least substantially sintered active material can be defined by a range such as is in the range of: about 100 percent sintered active material on a weight basis; about 98 percent sintered active material; about 90 to 100 (or any fractions there between) percent sintered active material on a weight basis; about 95 to about 100 percent sintered active material on a weight basis; about 92 to about 98percent sintered active material; about 94 to about 96 percent sintered active material; about 98 percent to about 100 sintered active material on a weight basis; or about 90, 91, 92, 93, 94, 95, 96, 97, 98, or 99 (or any fractions there between) percent sintered active material on a weight basis.

In an embodiment, on a weight basis, the anode electrode and/or cathode electrode may be comprised of about 81 to about 90 (or any integers or fractions there between) percent sintered active material, active material, and/or sintered material.

In an embodiment, on a weight basis, the anode electrode and/or cathode electrode may be comprised of about 71 to about 80 (or any integers or fractions there between) percent sintered active material, active material, and/or sintered material.

In an embodiment, on a weight basis, the anode electrode and cathode electrode may be comprised of about 61 to about 70 (or any integers or fractions there between) percent sintered active material, active material, and/or sintered material.

The percent (on a weight basis) of sintered active material, active material, and/or sintered material thickness may be less than the boundaries listed herein; and may include any numbers, fractions, or subranges within the boundaries (or extension beyond the boundaries) disclosed herein.

In an embodiment, an anode buffer structure 33 may disposed between said anode current collector 29 and said anode electrode 13. In an embodiment, a cathode buffer structure 35 may be disposed between said cathode current collector 31 and said cathode electrode 35. In an embodiment, an anode buffer structure 33 may be disposed between said anode current collector 29 and said anode electrode 13 and a cathode buffer structure 35 may be disposed between said cathode current collector 31 and said cathode electrode 15. In an embodiment, the said anode buffer structure 33 and/or said cathode buffer structure 35 may be comprised of a: battery binder material; conductive additive material; or battery binder material and conductive material. Examples of a battery binder material may include, but not limited thereto, one or more of any combination of the following: polyvinylidene difluoride (PVDF); styrene butadiene rubber (SBR), carboxymethyl cellulose (CMC), or polyacrylonitrile; or the like. Examples of a conductive additive material may include, but not limited thereto, one or more of any combination of the following: carbon black, graphite, carbon nanotubes, or graphene; or the like. Any metallic material is conductive and may be used but are considered expensive and heavy.

Still referring to FIG. 1, FIG. 2, and FIG. 15, wherein said ionic contact includes said electrolyte 17 dispersed within the pores 44 and 46 in said anode electrode 13 and said cathode electrode 15, respectively, and in channels 24 of said separator 23. The channels 24 of said separator 23 may be passages, pores or the like. Electrolyte may not be intended to be in the buffer structures but such may occur. In an embodiment, said separator 23 itself shall provide ionic conductive contact if said separator is solid state electrolyte type or polymer electrolyte type. In an embodiment, the separator 23 may not have channels or pores, for example, if it's solid state electrolyte type or polymer electrolyte type. For embodiments that include solid state or polymer electrolytes, they may be nonporous and ionically conducting but electrically insulating (so they serve both the “separator” function of preventing shorting and provide ion transport themselves, as opposed to through the electrolyte filled into their channels or pores which may be the case for the electrolyte separators discussed herein). Also, in an embodiment there may be hybrid type electrolytes where the solid state or polymer electrolyte has pores which are filled with another electrolyte type. There are also gel electrolytes and polymer electrolytes swollen with liquid electrolyte.

Still referring to FIG. 1, FIG. 2, and FIG. 15, in an embodiment said anode electrode 13 has a thickness about 400 μm (i.e., about 4mm). In an embodiment said anode electrode 13 may have a thickness in the range of, but not limited thereto, the following ranges: about 100 μm to about 1,000 μm (i.e., between about 0.1mm and about 1mm); about 150 μm to about 400 μm (i.e., between about 0.15mm and about 0.4mm); about 250 μm to about 800 μm (i.e., between about 0.25mm and about 0.8mm); about 270 μm to about 800 μm (i.e., between about 0.27mm and about 0.8mm); about 350 μm to about 500 μm (i.e., between about 0.35mm and about 0.5mm); about 300 μm to about 800 μm (i.e., between about 0.3 mm and about 0.8mm); about 350 μm to about 400 μm (i.e., between about 0.35mm and about 0.4mm); about 400 μm to about 800 μm (i.e., between about 0.4mm and about 0.8 mm); about 450 μm to about 600 μm (i.e., between about 0.45mm and about 0.6mm); about 500 μm to about 800 μm (i.e., between about 0.5mm and about 0.8mm); about 800 μm to about 1,000 μm (i.e., between about 0.8mm and about 1mm); about 200 μm to about 2,000 μm (i.e., between about 0.2mm and about 2mm); about 250 μm to about 2,000 μm (i.e., between about 0.25mm and about 2mm); about 270 μm to about 2,000 μm (i.e., between about 0.27mm and about 2mm); about 300 μm to about 2,000 μm (i.e., between about 0.3 mm and about 2mm); about 1,000 μm to about 5,000 μm (i.e., between about 1mm and about 5mm); about 1,000 μm to about 2,500 μm (i.e., between about 1mm and about 2.5 mm); about 2,500 μm to about 5,000 μm (i.e., between about 2.5mm and about 5mm); about 4,000 μm to about 5,000 μm (i.e., between about 4mm and about 5mm); or about 100 μm to about 5,000 μm (i.e., between about 0.1mm and about 5mm). The thickness may be greater than or less than the boundaries listed herein. The thickness may include any numbers, fractions, or subranges within the boundaries (or extension beyond the boundaries) disclosed herein.

Still referring to FIG. 1, FIG. 2, and FIG. 15, in an embodiment said cathode electrode 15 has a thickness about 400 μm (i.e., about 4mm). In an embodiment said cathode electrode 15 may have a thickness in the range of, but not limited thereto, the following ranges: about 100 μm to about1,000 μm (i.e., between about 0.1mm and about 1 mm); about 150 μm to about 400 μm (i.e., between about 0.15mm and about 0.4mm); about 250 μm to about 800 μm (i.e., between about 0.25mm and about 0.8mm); about 270 μm to about 800 μm (i.e., between about 0.27mm and about 0.8mm); about 350 μm to about 500 μm (i.e., between about 0.35mm and about 0.5mm); about 300 μm to about 800 μm (i.e., between about 0.3mm and about 0.8mm); about 350 μm to about 400 μm (i.e., between about 0.35mm and about 0.4mm); about 400 μm to about 800 μm (i.e., between about 0.4 mm and about 0.8mm); about 450 μm to about 600 μm (i.e., between about 0.45mm and about 0.6mm); about 500 μm to about 800 μm (i.e., between about 0.5mm and about 0.8 mm); about 800 μm to about 1,000 μm (i.e., between about 0.8mm and about 1mm); about 200 μm to about 2,000 μm (i.e., between about 0.2mm and about 2mm); about 250 μm to about 2,000 μm (i.e., between about 0.25mm and about 2mm); about 270 μm to about 2,000 μm (i.e., between about 0.27mm and about 2mm); about 300 μm to about 2,000 μm (i.e., between about 0.3mm and about 2mm); about 1,000 μm to about 5,000 μm (i.e., between about 1mm and about 5mm); about 1,000 μm to about 2,500 μm (i.e., between about 1mm and about 2.5mm); about 2,500 μm to about 5,000 μm (i.e., between about 2.5mm and about 5mm); about 4,000 μm to about 5,000 μm (i.e., between about 4mm and about 5mm); or about 100 μm to about 5,000 μm (i.e., between about 0.1 mm and about 5 mm). The thickness may be greater than or less than the boundaries listed herein. The thickness may include any numbers, fractions, or subranges within the boundaries (or extension beyond the boundaries) disclosed herein.

Still referring to FIG. 1, FIG. 2, and FIG. 15, in an embodiment said anode current collector 29 and/or said cathode current collector 31 are in the shape of a frame or border. In an embodiment the frame-shaped or border-shaped current collector can match the geometry of the cell or battery.

Still referring to FIG. 1, FIG. 2, and FIG. 15, in an embodiment said respective active material of each said anode electrode and said cathode electrode may comprise, but not limited thereto, any combination of at least one or more of the following:
a. Li metal anode and Li₄Ti₅O₁₂ cathode;
b. Li metal anode and LiN₂O₄ cathode, where N can be: any transition metal in isolation or combination of multiple transition metals, Al in isolation or in combination of one or more transition metals, or any alkali metal in isolation or combination of multiple alkali metals;
c. Li₄Ti₅O₁₂ anode and LiMO₂ cathode, where M can be: any transition metal in isolation or combination of multiple transition metals, Al in isolation or in combination of one or more transition metals, or any alkali metal in isolation or combination of multiple alkali metals;
d. Li₄Ti₅O₁₂ anode and LiM₂O₄ cathode, where M can be: any transition metal in isolation or combination of multiple transition metals, Al in isolation or in combination of one or more transition metals, or any alkali metal in isolation or combination of multiple alkali metals;
e. LiN₂O₄ anode and LiM₂O₄ cathode, where N can be: any transition metal in isolation or combination of multiple transition metals, Al in isolation or in combination of one or more transition metals, or any alkali metal in isolation or combination of multiple alkali metals, and where M can be: any transition metal in isolation or combination of multiple transition metals, Al in isolation or in combination of one or more transition metals, or any alkali metal in isolation or combination of multiple alkali metals;
f. Li₄Ti₅O₁₂ anode and LiNiₓMn_{y}Co_{z}O₂ cathode, where x+y+z=1;
g. LiN₂O₄ anode and LiNiₓMn_{y}Co_{z}O₂ cathode; where N can be: any transition metal in isolation or combination of multiple transition metals, Al in isolation or in combination of one or more transition metals, or any alkali metal in isolation or combination of multiple alkali metals, and where x+y+z=1;
h. Li metal anode and LiMO₂ cathode, where M can be: any transition metal in isolation or combination of multiple transition metals, Al in isolation or in combination of one or more transition metals, or any alkali metal in isolation or combination of multiple alkali metals; or
i. Li metal anode and LiM₂O₄ cathode, where M can be: any transition metal in isolation or combination of multiple transition metals, Al in isolation or in combination of one or more transition metals, or any alkali metal in isolation or combination of multiple alkali metals.

In an embodiment, some transition metals that may be used include, for example but not limited thereto, one or more of any combination of the following: Iron (Fe), Titanium (Ti), cobalt (Co), manganese (Mn), vanadium (V), nickel (Ni), chromium (Cr), or the like.

In an embodiment, some specific versions of the active material that may be used include, for example but not limited thereto, one or more of any combination of the following:

a. Li metal anode and LiCoO₂ (LCO) cathode,

b. Li metal anode and LiMn₂O₄ (LMO) cathode,

c. Li₄Ti₅O₁₂ (LTO) anode and LiCoO₂ (LCO) cathode,

d. Li₄Ti₅O₁₂ (LTO) anode and LiMn₂O₄ (LMO) cathode, or

e. Li metal anode and LiNi_{1/3}Mn_{1/3}Co_{1/3}O₂ (NMC or NCM) cathode.

Still referring to FIG. 1, FIG. 2, and FIG. 15, in an embodiment said respective active material of each said anode electrode and said cathode electrode may comprise, but not limited thereto, any combination of at least one or more of the following:
a. Na metal anode and Na₄Ti₅O₁₂ cathode;
b. K metal anode and K₄Ti₅O₁₂ cathode;
c. Na metal anode and NaMO₂ cathode, where M can be: any transition metal in isolation or combination of multiple transition metals, Al in isolation or in combination of one or more transition metals, or any alkali metal in isolation or combination of multiple alkali metals;
d. K metal anode and KMO₂ cathode, where M can be: any transition metal in isolation or combination of multiple transition metals, Al in isolation or in combination of one or more transition metals, or any alkali metal in isolation or combination of multiple alkali metals;
e. Na metal anode and NaM₂O₄ cathode, where M can be: any transition metal in isolation or combination of multiple transition metals, Al in isolation or in combination of one or more transition metals, or any alkali metal in isolation or combination of multiple alkali metals; or
f. K metal anode and KM₂O₄ cathode, where M can be: any transition metal in isolation or combination of multiple transition metals, Al in isolation or in combination of one or more transition metals, or any alkali metal in isolation or combination of multiple alkali metals;
g. Na₄Ti₅O₁₂ anode and NaMO₂ or NaM₂O₄ cathode, where M can be: any transition metal in isolation or combination of multiple transition metals, Al in isolation or in combination of one or more transition metals, or any alkali metal in isolation or combination of multiple alkali metals; or
h. K₄Ti₅O₁₂ anode and KMO₂ or KM₂O₄ cathode, where M can be: any transition metal in isolation or combination of multiple transition metals, Al in isolation or in combination of one or more transition metals, or any alkali metal in isolation or combination of multiple alkali metals.

If sodium (Na) or potassium (K) metal is used instead Lithium (Li) metal then the cation charge carrier in the electrolyte would change to Na or K (rather than Li as the cation charge carrier used with the Li metal).

Still referring to FIG. 1, FIG. 2, and FIG. 15, in an embodiment said anode current collector is configured to be in communication with an external circuit and said cathode current collector is configured to be in communication with an external circuit.

Still referring to FIG. 1, FIG. 2, and FIG. 15, in an embodiment, said anode electrode 13 and/or said cathode electrode 15 may free of: battery binder material, conductive additive material, or battery binder material and conductive additive material. For example, in an embodiment the battery binder material or conductive additive material should be burned out during the fabrication process. In an embodiment, said anode electrode 13 and/or said cathode electrode 15 may at least substantially free of: battery binder material, conductive additive material, or battery binder material and conductive additive material. At least substantially free is defined as one of: about 100 free, about 98 free, about 90 to 100 free, about 95 to about 100 free, about 92 to about 98 free, about 94 to about 96 free, or about 98 percent to about 100 free.

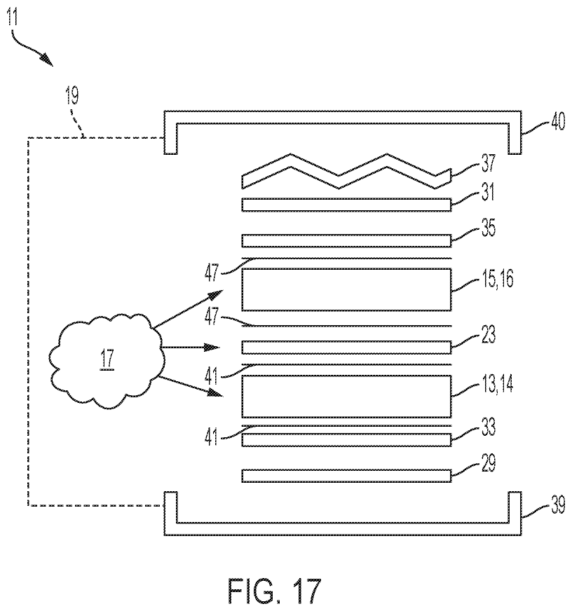

FIG. 17 schematically illustrates an exploded view of an embodiment of an electrochemical device in as similarly disclosed in FIG. 15, but wherein said anode electrode 13 and/or said cathode electrode 15 may be further configured with a coating 41 or 47 disposed on the exterior so as to be an integrated, operable portion of said anode electrode 13 or cathode electrode 15, respectively.

Still referring to FIG. 1, FIG. 2, and FIG. 15, in an embodiment, said anode electrode 13 and/or said cathode electrode 15 may be further configured with a coating (not shown) disposed on the exterior so as to be an integrated, operable portion of said anode electrode 13 or cathode electrode 15, respectively.

Still referring to FIG. 1, FIG. 2, and FIG. 15, in an embodiment, said active material 14 of said anode electrode 13 is about 60 percent solid by volume fraction. In an embodiment said active material 14 of said anode electrode 13 is in the range of, but not limited thereto, the following ranges: about 35 percent solid by volume fraction to about 60 percent solid by volume fraction; about 45 percent solid by volume fraction to about 70 percent solid by volume fraction; about 60 percent solid by volume fraction to about 70 percent solid by volume fraction; about 35 percent solid by volume fraction to about 80 percent solid by volume fraction; about 65 percent solid by volume fraction to about 70 percent solid by volume fraction; about 65 percent solid by volume fraction to about 75 percent solid by volume fraction; about 70 percent solid by volume fraction to about 75 percent solid by volume fraction; or about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 percent solid by volume fraction. The volume fraction may be greater than or less than the boundaries listed herein. The volume fraction may include any numbers, fractions, or subranges within the boundaries (or extension beyond the boundaries) disclosed herein.

Still referring to FIG. 1, FIG. 2, and FIG. 15, in an embodiment, said active material 16 of said cathode electrode 15 is about 60 percent solid by volume fraction. In an embodiment said active material 16 of said cathode electrode 15 is in the range of, but not limited thereto, the following ranges: about 35 percent solid by volume fraction to about 60 percent solid by volume fraction; about 45 percent solid by volume fraction to about 70 percent solid by volume fraction; about 60 percent solid by volume fraction to about 70 percent solid by volume fraction; about 35 percent solid by volume fraction to about 80 percent solid by volume fraction; about 65 percent solid by volume fraction to about 70 percent solid by volume fraction; about 65 percent solid by volume fraction to about 75 percent solid by volume fraction; about 70 percent solid by volume fraction to about 75 percent solid by volume fraction; or about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 percent solid by volume fraction. The volume fraction may be greater than or less than the boundaries listed herein. The volume fraction may include any numbers, fractions, or subranges within the boundaries (or extension beyond the boundaries) disclosed herein.

Still referring to FIG. 1, FIG. 2, and FIG. 15, in an embodiment, considered to be thicker like electrodes, said anode electrode 13 and said cathode electrode 15 performs at one of the following:

electrode areal capacity of about 45 mAh/cm² and current density of about 1.28 mA/cm²;

electrode areal capacity of about 33 mAh/cm² and current density of about 2.56 mA/cm²;

electrode areal capacity of about 20 mAh/cm² and current density of about 6.4 mA/cm²; or

electrode areal capacity of about 8 mAh/cm² and current density of about 12.8 mA/cm².

The performance magnitude (electrode areal capacity and current density) may be greater than or less than the boundaries listed herein. The performance magnitude may include any numbers, fractions, or subranges within the boundaries (or extension beyond the boundaries) disclosed herein.

Still referring to FIG. 1, FIG. 2, and FIG. 15, in an embodiment, considered to be thinner like electrodes, said anode electrode 13 and said cathode electrode 15 performs at one of the following:

electrode areal capacity of about 18 mAh/cm² and current density of about 1.848 mA/cm²;

electrode areal capacity of about 16 mAh/cm² and current density of about 3.696 mA/cm²;

electrode areal capacity of about 12.5 mAh/cm² and current density of about 4.62 mA/cm²; or

electrode areal capacity of about 21.4 mAh/cm² and current density of about 0.462 mA/cm².

The performance magnitude (electrode areal capacity and current density) may be greater than or less than the boundaries listed herein. The performance magnitude may include any numbers, fractions, or subranges within the boundaries (or extension beyond the boundaries) disclosed herein.

Still referring to FIG. 1, FIG. 2, and FIG. 15, in an embodiment, said anode electrode 13 and said cathode electrode 15 performs at electrode areal capacity at one of the following:

about 10 mAh/cm²;

about 15 mAh/cm²;

about 25 mAh/cm²;

about 35 mAh/cm²;

about 50 mAh/cm²;

about 65 mAh/cm²;

about 75 mAh/cm²;

about 80 mAh/cm²;

about 90 mAh/cm²; or

a range of about 10 mAh/cm² through about 90 mAh/cm².

The electrode areal capacity may be greater than or less than the boundaries listed herein. The electrode areal capacity may include any numbers, fractions, or subranges within the boundaries (or extension beyond the boundaries) disclosed herein.

Still referring to FIG. 1, FIG. 2, and FIG. 15, in an embodiment, said anode electrode 13 and said cathode electrode 15 performs at current density at one of the following:

about 0.1 mA/cm²;

about 0.25 mA/cm²;

about 0.50 mA/cm²;

about 0.75 mA/cm²;

about 1.0 mA/cm²;

about 2.5 mA/cm²;

about 5.0 mA/cm²;

about 7.5 mA/cm²;

about 10.0 mA/cm²;

about 12.50 mA/cm²;

about 15.0 mA/cm²;

about 17.50 mA/cm²;

about 20.0 mA/cm²; or

a range of about 0.1 mA/cm² through about 20.0 mA/cm²

The electrode current density may be greater than or less than the boundaries listed herein. The electrode current density may include any numbers, fractions, or subranges within the boundaries (or extension beyond the boundaries) disclosed herein.

Still referring to FIG. 1, FIG. 2, and FIG. 15, in an embodiment, a be configured to at least partially enclose said device.

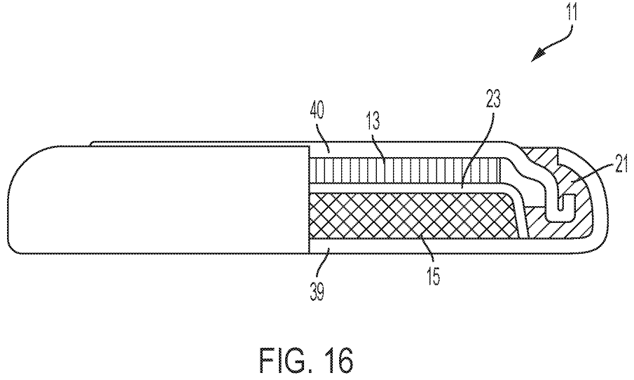

FIG. 16 schematically illustrates a partial side view and partial cross-section view of an embodiment of an electrochemical device as disclosed herein, which is implemented in the button cell or coin cell type. An anode electrode 13 is in electronic communication with an anode current collector (not shown). A cathode electrode 15 is in electronic communication with a cathode current collector, which in this embodiment the base or case 39 may serve as the current collector (although it is not labeled numerically as a current collector for the cathode). A separator 23 comprised of channels, passages or pores (not shown) is disposed between said anode electrode 13 and said cathode electrode 15. An electrolyte (not shown) is in ionic contact with said anode electrode 13, said cathode electrode 15, and said separator 23, and which also fills said porous spaces within the anode electrode and cathode electrode. A gasket 21 may be provided to seal the cell to prevent electrolyte from escaping. In an embodiment, a gasket may be provided to perform two functions, such as sealing the cell and applying compressive forces in the architecture. A cap, base, or can 39 or the like and case or cap 40 may be provided to enclose the device.

As noted above, an embodiment of an electrochemical device as disclosed herein, may be implemented in the button cell or coin cell type architecture or style. Moreover, an embodiment of an electrochemical device as disclosed herein, may be implemented in other formats other than the button cell or coin cell type architecture. For, example, an embodiment of the electrochemical device may be implemented, but not limited thereto, in the following architectures or styles: pouch cells, prismatic cells, flat cells, cylindrical cells, wound cells, thin film cells, sealed cells, or the like. The range of applications for an embodiment of an electrochemical device is vast among various cell architectures. An embodiment of an electrochemical device may be used for, but not limited thereto, the following: consumer electronics; wireless sensors; biomedical devices; medical instruments; power tools; electric vehicles; low temperature applications; high temperature applications; unmanned aerial vehicles and crafts; unmanned land and water vehicles and crafts; satellites; drill heads; backup power; stationary energy storage; etc. For example, a coin cell architecture may be implemented for various small electronic device applications such as, but not limited thereto, computer motherboards; watches; wearable devices on humans; animals or other subjects; implantable medical devices; car keys; bicycle lights; etc.

Any number of cells as disclosed herein may be utilized together as desired or required, such as to provide and meet, among other things, the environmental, anatomical, power, and structural demands and operational requirements. In an embodiment, multiple batteries may be wired or connected in series, parallel, or both series and parallel. In an embodiment, a battery bank may be composed of a single battery or multiple interconnected batteries that that are wired or connected to work as one larger battery or one or more spans of batteries.

An embodiment may be provided in a form of a powerbank, such as for, but not limited thereto, charging smartphones, mobile tablet devices, and other USB charged devices, etc. They can also be used as a power supply for various USB powered (or other format powered) devices such as lights, small fans, electric appliances, or the like. A powerbank may be a portable device that can supply power from its built-in batteries through a USB port (or other format port). They may also recharge with USB power supply.

An embodiment may be provided in a form of a stationary battery plant(s) or room(s). An embodiment may be provided in a form of charge station(s) or mobile phone charger.

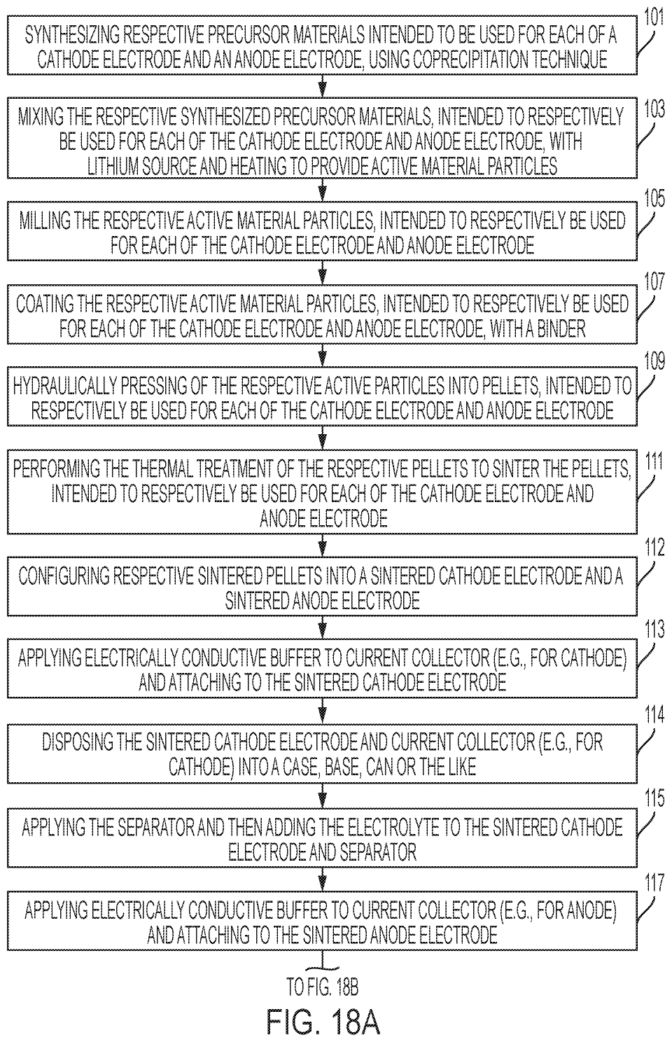

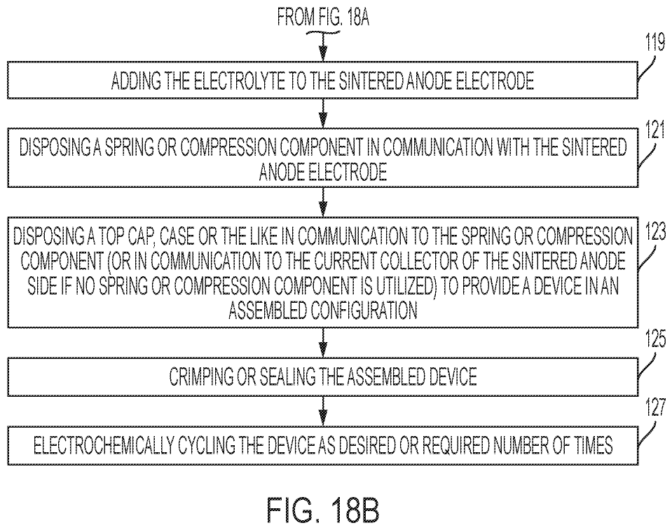

FIGS. 18(A)-(B) provide a flowchart of fabricating various aspects of an embodiment or embodiments of an electrochemical device. Step 101 provides for the precursor synthesis of respective materials, intended to respectively be used for each of a cathode electrode and an anode electrode, which may entail synthesize precursor materials using coprecipitation. In particular, precipitate dissolved solutions of the transition metals of interest with a dissolved coprecipitating agent (most often oxalate, but may also use carbonate or hydroxide processes). For the LCO sintered electrode one may use a cobalt oxalate dihydrate precipitation. Alternative to synthesizing, one may obtain sub-micrometer particles if commercially available. LTO may be available, but all others need to be synthesized. The present inventors also made their own NMC precursor, which is an oxalate precipitation with a blend of transition metals (Ni, Mn, Co) dissolved.

Still referring to step 101, the detailed conditions in an embodiment may include for oxalate precursor synthesis, 1800 mL 62.8 mM Co(NO₃)₂.6H₂O (Fisher Reagent Grade) and 1800 mL 87.9 mM (NH₄)₂C₂O₄.H₂O (Fisher Certified ACS) were first prepared as separate solutions using deionized water, and both were heated to 50° C. Then Co(NO₃)₂.6H₂O solution was poured into (NH₄)₂C₂O₄.H₂O solution all at once. The solution was stirred at 800 rpm and maintained at 50° C. for 30 minutes. After that, the solid precipitate product was collected using vacuum filtration and rinsed with 4 L deionized water. The powder was dried in an oven exposed to the surrounding air atmosphere for 24 hours at 80° C.

Still referring to FIGS. 18(A)-(B), step 103 provides for the precursor calcination, which may entail mixing the respective precursor materials previously synthesized, intended to respectively be used for each of the cathode electrode and anode electrode, with a lithium salt, typically either lithium hydroxide or lithium carbonate; although the present inventors have also used lithium nitrate.

Still referring to step 103, the process would be to convert the precursor to LCO final active material, the oxalate particles were mixed with Li₂CO₃ (Fisher Chemical) powder with a Li:Co ratio of 1.02:1. The mixture was calcined in Carbolite CWF 1300 box furnace under an air atmosphere by heating to 800° C. with a ramp rate of 1° C./min. Upon reaching the target temperature of 800° C., the heat supplied to the furnace was turned off and it was allowed to cool to ambient temperature without any control over the cooling rate. This converts the cobalt oxalate dihydrate to lithium cobalt oxide battery active material. Different furnace programs might be employed for different materials (e.g. time, temp, ramp rate).

Still referring to FIGS. 18(A)-(B), step 105 provides for the respective active material particle milling, intended to respectively be used for each of the cathode electrode and anode electrode, which includes making sure the active material is a fine powder after the furnace firing, which allows for using hard milling and/or soft milling.

Still referring to step 105, a non-limiting example of the procedure includes: The resulting LCO material was ground by hand using mortar and pestle, and was further milled using Fritsch Pulverisette 7 planetary ball mill. For the ball milling, LCO powder was mixed with 5 mm diameter zirconia beads and milled for 5 hours at 300 rpm. The detailed materials characterization of the LTO and LCO materials used in this study, as well as their electrochemical characterization in conventional composite electrodes, can be found in previous reports. At large scale one would probably have to adapt this to a higher throughput process.

Still referring to FIGS. 18(A)-(B), step 107 provides for coating respective active material particles, intended to respectively be used for each of the cathode electrode and anode electrode, with a binder. The pellets of the active material press more uniformly if they are coated with a binder which eventually burns off during a subsequent step. Coating with a binder is not absolutely required but does allow for better quality pellets.

Still referring to step 107, a non-limiting example of coating process may include the cathode and anode pellets were independently and separately prepared using the same procedure. First, 1 g active powder was mixed with 2 mL 1 wt. % polyvinyl butyral (Pfaltz& Bauer) dissolved in ethanol (Acros). Mortar and pestle were used to facilitate mixing the slurry, and the hand mixing was continued until all solvent was evaporated.

Still referring to FIGS. 18(A)-(B), step 109 provides for hydraulic pressing (or the like) of the respective active particles into pellets, intended to respectively be used for each of the cathode electrode and anode electrode (which optionally may have the binder coating thereon as recited in step 107). The hydraulic pressing or other types of pressing (or other type of processing) provides for forcing the particles together so they can then be further sintered and processed. Other types of applications (or processing) where pressure is applied to force materials together in a specific geometry may be implemented as well. Some examples of such processes (i.e., processing) may include, but not limited thereto, the following: spark plasma sintering; injection molding; and spray coating techniques (e.g. thermal spray coating).

Still referring to step 109, a non-limiting example of the hydraulic pressing procedure includes providing wherein the mixture powder was loaded into a 13 mm Carver pellet die. For the cell with thin electrodes, 0.2 g powder was used for LCO, and 0.22 g powder was used for LTO. For the cell with thick electrodes, 0.26 g powder was used for both anode and cathode. Then, the powder was pressed within the pellet die with 12,000 lbf (pound-force) for 2 minutes in a Carver hydraulic press. In some approaches, one can change the amount of active material or the size of the die, but generally use the same force and duration.

Still referring to FIGS. 18(A)-(B), step 111 provides for the calcination of the respective pellets to sinter pellets, intended to respectively be used for each of the cathode electrode and anode electrode. Accordingly, the particles are sintered within the pellet geometry.

Still referring to step 111, a non-limiting example of the calcination of pellet to sinter pellets includes whereby the pellets were carefully extracted from the die intact and were sintered in a Carbolite CWF 1300 box furnace under an air atmosphere. The program used consisted of ramping from 25° C. to 700° C. at 1° C./min, holding at 700° C. for 1 hour, then cooling to 25° C. at 1° C./min. This may be an important and useful step. The higher the temperature and/or longer the hold at the top temperature the more sintered the pellet. More sintered pellets are higher energy density and less porosity, but in general much poorer performance because they have to be cycled extremely slowly.

Still referring to FIGS. 18(A)-(B), step 112 provides for configuring respective sintered pellets into a sintered cathode electrode and sintered anode electrode.

Still referring to FIGS. 18(A)-(B), step 113 provides for applying electrically conductive buffer to current collector (for cathode) and attach to sintered cathode electrode.

Still referring to step 113, a non-limiting example of the procedure includes, whereby the electrodes, comprised of porous disks containing only sintered electroactive materials, were assembled into full cells within CR2032 coin cells. The LCO pellets were attached to the bottom plate of the cell using carbon paste (1:1 weight ratio Super P carbon black (Alfa Aesar) to polyvinylidene difluoride (PVDF, Alfa Aesar) binder dissolved in N-methyl pyrrolidone (NMP, Sigma-Aldrich)) and dried for 12 hours in an oven in air at 80° C. The LTO pellets were pasted on the stainless steel spacer of the coin cell using the same paste and drying procedure.

Still referring to FIGS. 18(A)-(B), step 114 provides for disposing the sintered cathode electrode and current collector (for cathode) into a case, base, can or the like.

Still referring to FIGS. 18(A)-(B), step 115 provides adding electrolyte to the cathode electrode, apply the separator, and then adding electrolyte to the separator. Alternatively, step 115 may include applying the separator and then adding the electrolyte to cathode electrode and separator.

Still referring to step 115, a non-limiting example of the process may include, whereby the pellets attached to stainless steel were then transferred into an Ar-filled glove box (O₂ and H₂O both <1 ppm) for the remaining coin cell assembly steps. LTO and LCO electrodes were paired together while separated by a Celgard 2325 polymer separator. 16 drops of electrolyte (1.2 M LiPF₆ in 3:7 ethylene carbonate:ethyl methyl carbonate, purchased from BASF) were added.

Still referring to FIGS. 18(A)-(B), step 117 provides for applying electrically conductive buffer to current collector (for anode) and attach to sintered anode electrode.

Still referring to FIGS. 18(A)-(B), step 119 provides adding electrolyte to the sintered anode electrode.

Still referring to FIGS. 18(A)-(B), step 121 provides for adding a spring or compression component (such as wavespring or the like). In an embodiment, a spring or compression component may be optional. In an embodiment, a gasket may be utilized in a manner to provide the compressive forces instead of or in addition to a spring. In an embodiment, a gasket may be provided to seal the cell to contain the electrolyte within the cell. In an embodiment, a gasket may be provided for both functions of sealing the cell and applying compressive forces.

Still referring to FIGS. 18(A)-(B), step 123 provides for adding a top cap, case or the like to the spring (or to the current collector of the anode side if no spring or compression component is utilized to provide a device in an assembled configuration.

Still referring to FIGS. 18(A)-(B), step 125 provides for crimping the assembled device.

Still referring to FIGS. 18(A)-(B), step 127 provides for electrochemically cycling the device a predetermined number of times, such as desired, designated or required.

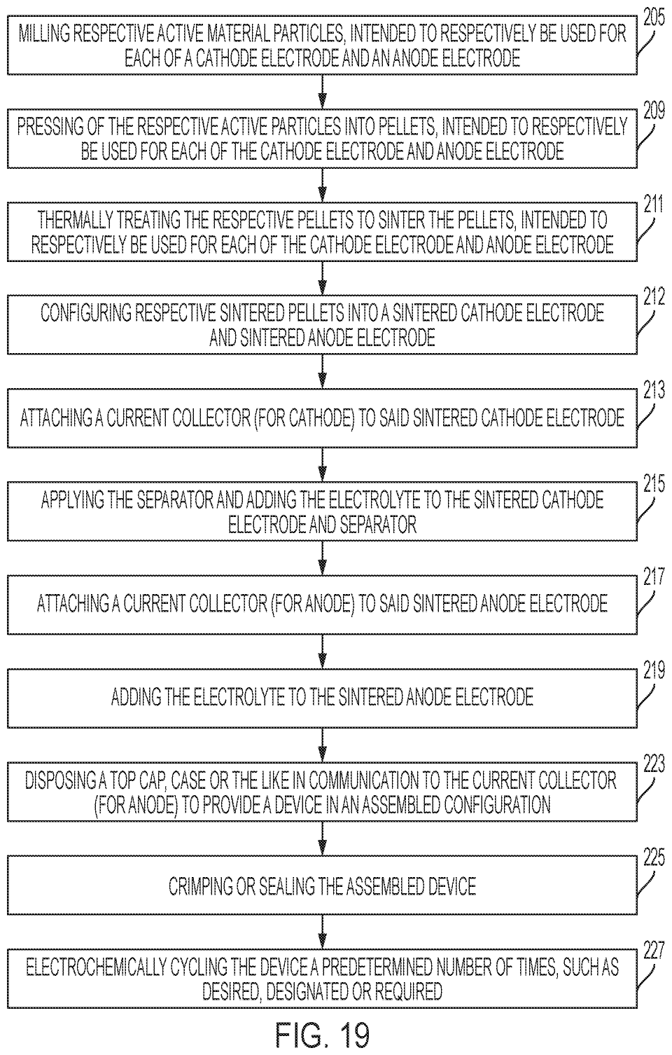

FIG. 19 provides a flowchart of fabricating various aspects of an embodiment or embodiments of an electrochemical device. Step 205 provides for milling respective active material particles, intended to respectively be used for each of a cathode electrode and an anode electrode. Step 209 provides for pressing of the respective active particles into pellets, intended to respectively be used for each of the cathode electrode and anode electrode. Step 211 provides for thermally treating the respective pellets to sinter the pellets, intended to respectively be used for each of the cathode electrode and anode electrode. Step 212 provides for configuring respective sintered pellets into a sintered cathode electrode and sintered anode electrode. Step 213 provides for attaching a current collector (for cathode) to said sintered cathode electrode. Step 215 provides for applying the separator and adding the electrolyte to the sintered cathode electrode and separator. Step 217 provides for attaching a current collector (for anode) to said sintered anode electrode. Step 219 provides for adding the electrolyte to the sintered anode electrode. Step 223 provides for disposing a top cap, case or the like in communication to the current collector (for anode) to provide a device in an assembled configuration. Step 225 provides for crimping or sealing the assembled device. Step 227 provides for electrochemically cycling the device a predetermined number of times, such as desired, designated or required.

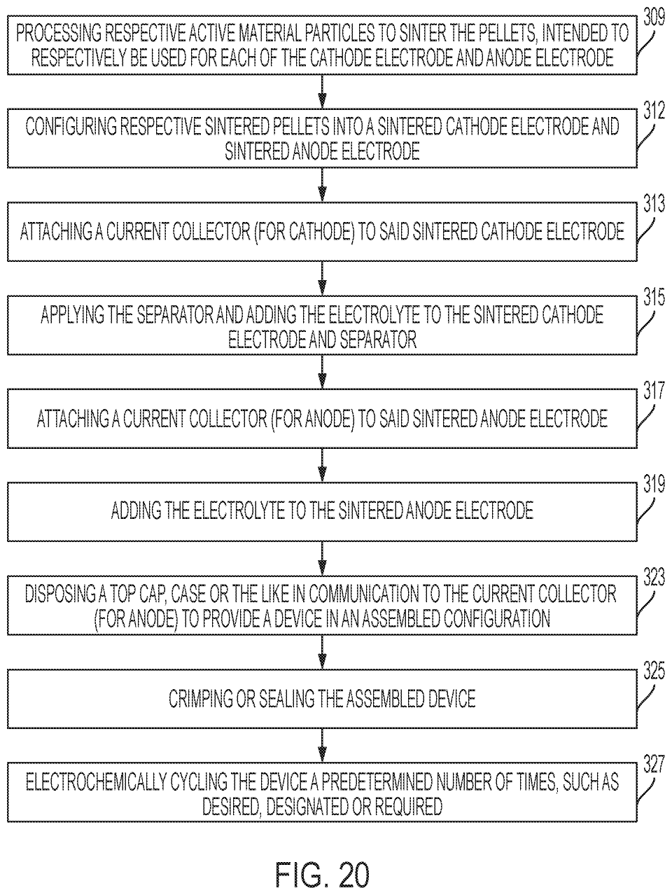

FIG. 20 provides a flowchart of fabricating various aspects of an embodiment or embodiments of an electrochemical device. Step 309 provides for processing respective active material particles to sinter the pellets, intended to respectively be used for each of the cathode electrode and anode electrode. Step 312 provides for configuring respective sintered pellets into a sintered cathode electrode and sintered anode electrode. Step 313 provides for attaching a current collector (for cathode) to said sintered cathode electrode. Step 315 provides for applying the separator and adding the electrolyte to the sintered cathode electrode and separator. Step 317 provides for attaching a current collector (for anode) to said sintered anode electrode. Step 319 provides for adding the electrolyte to the sintered anode electrode. Step 323 provides for disposing a top cap, case or the like in communication to the current collector (for anode) to provide a device in an assembled configuration. Step 325 provides for crimping or sealing the assembled device. Step 327 provides for electrochemically cycling the device a predetermined number of times, such as desired, designated or required.

Provided below is a non-limiting list of abbreviations of compositional formulas for the following compounds:

a. LTO: lithium titanate or lithium titanium oxide, (Li₄Ti₅O₁₂ ),

b. LMO: lithium ion manganese oxide, (LiMn₂O₄ ,),

c. NMC or NCM: lithium nickel manganese cobalt oxide (LiNi_{1/3}Mn_{1/3}Co_{1/3}O₂), and

d. LCO: lithium cobalt oxide (LiCoO₂ ).

Other compositional formulas are possible for the named compounds. For instance, there are also many examples of where slightly different compositions are used (doping, for example) and the same abbreviations are used.

Transition metals in an embodiment may include any one or more of the following: Scandium, Titanium, Vanadium, Chromium, Manganese, Iron, Cobalt, Nickel, Copper, Zinc, Yttrium, Zirconium, Niobium, Molybdenum, Technetium, Ruthenium, Rhodium, Palladium, Silver, Cadmium, Hafnium, Tantalum, Tungsten, Rhenium, Osmium, Iridium, Platinum, Gold, Mercury, Rutherfordium, Dubnium, Seaborgium, Bohrium, Hassium, Meitnerium, Ununnilium, Unununium, and Ununbium, The following may be considered as transition metals: Lanthanum, sometimes (often considered a rare earth, lanthanide); Actinium, sometimes (often considered a rare earth, actinide); Roentgenium; and Copernicium (presumably is a transition metal).

Transition metals in an embodiment may include any one or more of the following: Scandium, Titanium, Vanadium, Chromium, Manganese, Iron, Cobalt, Nickel, Copper, Zinc, Yttrium, Zirconium, Niobium, Molybdenum, Technetium, Ruthenium, Rhodium, Palladium, Silver, Cadmium, Hafnium, Tantalum, Tungsten, Rhenium, Osmium, Iridium, Platinum, Gold, or Mercury.

### EXAMPLES

Practice of an aspect of an embodiment (or embodiments) of the invention will be still more fully understood from the following examples and experimental results, which are presented herein for illustration only and should not be construed as limiting the invention in any way.

### Example and Experimental Results Set No. 1

In an embodiment, this disclosure shall describe, among other things, battery cells where both the anode and cathode are comprised of sintered electrodes that contain only the electroactive materials, a less common electrode architecture for Li-ion batteries.[4] These sintered electrodes consist of close-packed solid active material particles (>60% solid by volume) compressed into porous thin films. These thin films are electronically conductive, and thus do not require conductive additives. In addition, the connections between particles are mechanically robust and thus binders are also not required, thus the sintered electrodes do not have any of the inactive additives typically used in conventional Li-ion composite electrodes. Using hydraulic pressing to fabricate the electrodes enables thicker electrodes than those typically achieved with calendared composites. The pressing of a single component, the active material particles, mitigates some electrode heterogeneity. Furthermore, the pressing step achieves random close packing regardless of particle morphology, facilitating the use of small, high-rate-capability active material particles without major sacrifices to electrode packing density.[15] Sintered electrodes have higher energy densities on an areal basis than state-of-the-art composite electrodes,[16] and the increased thickness of the electrodes suggests that if they could be produced in a stacked configuration that due to the lower fraction of the cell allocated to separators and current collectors that sintered electrodes may even be competitive with wound composite electrode architectures.[17]

Herein, regarding an embodiment, fabrication of Li-ion full cells will be reported where both electrodes were comprised of only sintered active materials—free of binder and conductive additives. The coin cells reported in this study have extremely high areal capacities −21.4 mAh cm⁻² and 45.2 mAh/cm⁻². For perspective, commercial Li-ion electrode pairs have been reported in a range generally up to 25 mg active material per cm², corresponding to a capacity of about 3.75 mAh cm⁻² for common cathode material LiCoO₂ (LCO).[2, 18] While other reports have paired sintered electrodes with lithium metal which results in the highest energy density, an aspect of an embodiment shall demonstrate, among other things, that lithium metal thin film electrodes result in significant performance and cycle life limitations when paired with high capacity sintered electrode cells. The high energy density sintered electrode architectures provide a promising route to high energy density Li-ion cells, and further improvements towards mitigating rate capability limitations in these cells would provide a promising strategy to designing high energy density battery packs.

### Results and Discussion

### Sintered Electrode Half Cells

LCO was chosen for evaluation towards use as the cathode in sintered electrode full cells, in part because it was previously demonstrated in the literature as a successful sintered electrode material.[4] LCO is a good candidate for use as a sintered electrode material because it has reasonably high energy density, relatively high electronic conductivity after slight delithiation, and modest strain with intercalation/deintercalation. [4, 19] Relatively high electronic conductivity is important for sintered electrodes because the active material itself must provide all of the electronic conduction from the particles to the current collector, and as will be described in the cell fabrication some of the active material particles in the electrode will be many hundreds of micrometers away from the current collector. Modest intercalation strain is needed because large volume change in the electrode material with cycling would likely lead to fracture and failure of the electrode because it is comprised of only sintered active material. Strain of more than a few percent would be expected to break particle-particle sintered connections.

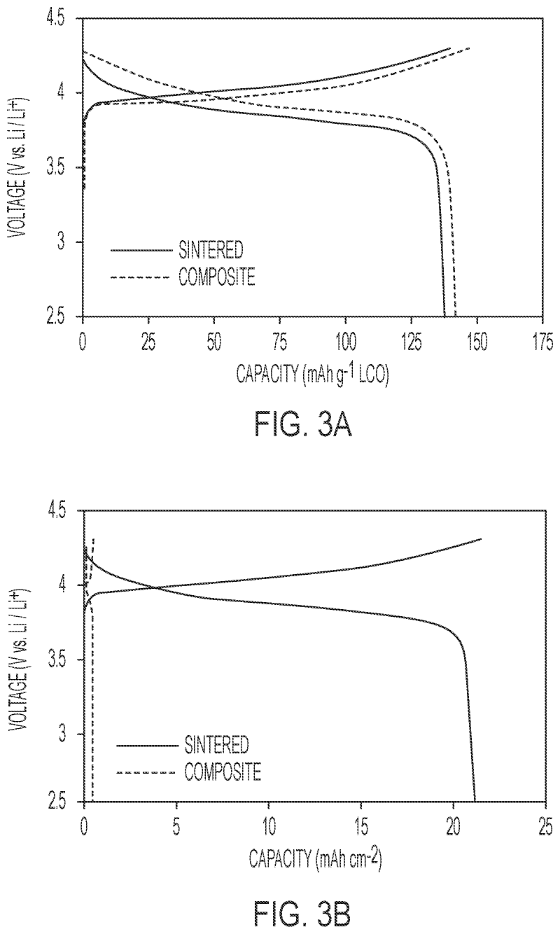

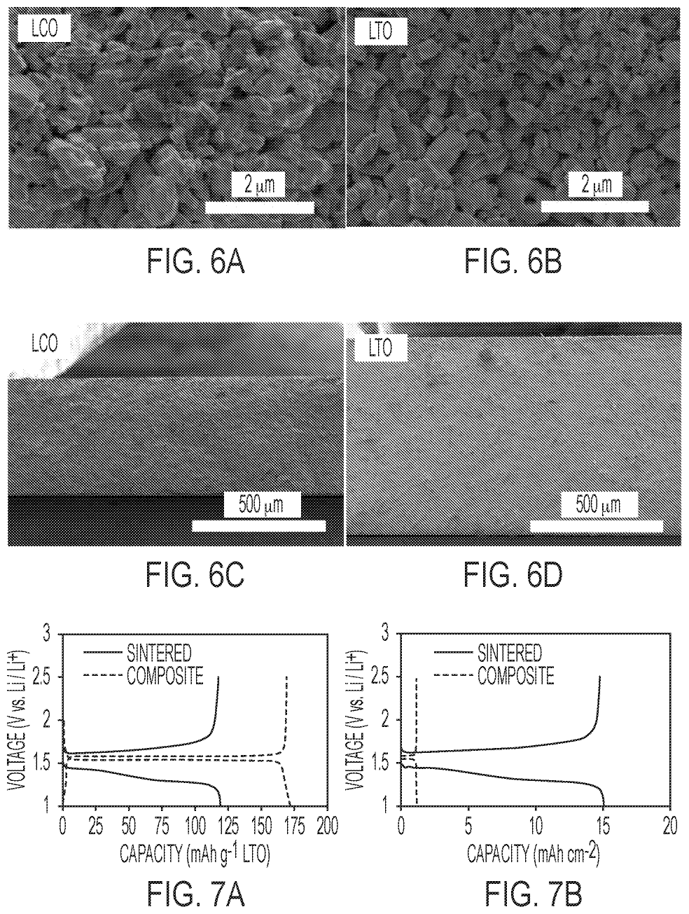

LCO powder was synthesized as described in the Experimental section, pressed into 440 μm thick pellets (surface morphology can be seen in FIG. 6 discussed herein), sintered, and assembled into half cells with lithium metal anodes to evaluate the electrochemical performance. For comparison with the Li/LCO sintered electrodes, Li/LCO cells were also fabricated using conventional LCO composite electrodes where the composite was comprised of a blend of active material, carbon black, and binder with relative weight fractions of 80:10:10 active material:carbon black:binder. As shown in FIG. 3, the sintered electrodes have only slightly lower capacity than the composites on a gravimetric basis, but much higher capacity on an areal basis. At C/20 (7.5 mA g⁻¹ LCO), the capacity of the sintered LCO electrode was 97% that of the composite LCO electrode on a gravimetric basis, but 4000% of the composite electrode on an areal basis. The round trip energy efficiency was 93.4% for the sintered electrode and 94.4% for the composite electrode. The volumetric energy density of the Li/LCO cell with the sintered electrode was calculated for just the active components of the cell and was very high −1435 Wh L⁻¹ when discharged at a rate of 77.9 W L⁻¹. Note that the full 100 □m thick lithium metal anode, 400 □m thick LCO cathode with 68 vol % solid active material, electrolyte, and separator were included in this energy density, but the current collectors and cell casing were not included.

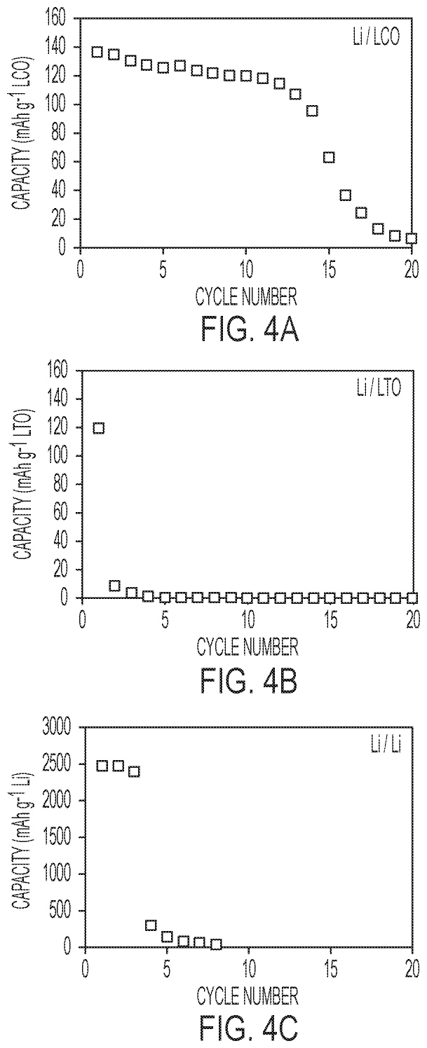

While the energy density of the Li/LCO cell with a sintered LCO electrode was very high, the cycle life was limited (See FIG. 4A). The cell experienced abrupt capacity loss after 15 charge/discharge cycles at C/20. This low cycle life made accurate determination of the rate capability of the sintered electrodes difficult. The present invent tor hypothesized that the low cycle life was caused by the extremely deep lithium stripping and plating with each discharge and charge cycle, respectively. For example, assuming the lithium were to form a dense film with the reversible stripping and plating cycles, the early discharge cycles shown in FIG. 4A correspond to stripping a thickness of approximately 130 μm of lithium metal during each cycle. That same approximately 130 □m of lithium metal would then be plated on the charge cycle. This substantial restructuring of the lithium anode with each cycle would be expected to result in large amounts of solid electrolyte interphase (SEI) formation and thus electrolyte consumption, as well as potential dendrite growth.[20] In a previous literature report characterizing sintered electrode cathodes, lithium metal and electrolyte were replaced periodically to enable extended cycling.[4] The challenge with extended cycling is expected to generally be an issue in thick sintered electrode cells when paired with lithium metal because of their high areal energy density, which is not an issue typically observed with lithium metal anode coin cells when paired with composite cathodes. This is because composite cathodes typically have only a couple mAh cm⁻² capacity (e.g., FIG. 3B) and can be paired with lithium metal anodes that may be 200 □m thick, in which case assuming the lithium metal is a dense thin film it would contain 41 mAh cm⁻² of capacity. Thus, even with significant loss of lithium metal due to loss to SEI formation, because there are only a couple mAh of capacity on the cathode the cells usually do not have problems reaching hundreds of charge/discharge cycles. However, for the sintered electrodes in this study the cathode contains >20 mAh—thus the cathode capacity goes from being ˜5% of the lithium metal anode for the conventional composite electrode case to ˜50% of the lithium metal anode in the sintered electrode case. Thus the lithium metal has to contend with extremely large swings in thickness with each cycle of stripping/plating and there is new SEI formation with each cycle. These combined factors are likely the cause of the relatively low number of cycles the sintered LCO electrode achieved when paired with lithium metal anodes.

As an alternative to using lithium metal as the anode, sintered Li₄Ti₅O₁₂ (LTO) spinel was investigated in an effort to achieve extended cycling without resorting to opening the cell and periodically replacing the electrolyte and lithium metal. LTO was chosen as the material for the anode material due to its 1.55 V redox potential vs. Li/Li⁺, which is within the stability window of the electrolyte and thus limits SEI formation. Though the higher redox potential reduces the energy density of Li-ion batteries with LTO relative to lithium metal or graphite anodes, the higher potential results in LTO having high cycle life and safety. Also, LTO has very low strain during intercalation/deintercalation, suppressing particle fracture during cycling.[21, 22] Additionally, while LTO as synthesized is initially electrically insulating, the Li₇Ti₅O₁₂ phase formed during lithiation is highly conductive and has been shown to support cycling LTO without carbon additives in both composite and sintered electrodes. [23-25]

Since LTO has a low strain and the voltage is within the electrolyte stability window, it was expected to have high retention of electrochemical capacity with charge/discharge when processed into a sintered electrode due to minimization of pulverization of interparticle connections which would enable maintaining conductivity throughout the thin film. However, despite these material stability advantages, sintered LTO electrodes paired with lithium metal anodes were observed to have even lower cycle life than sintered LCO electrodes (FIG. 4B). The Li/LTO cell with a sintered LTO electrode successfully completed one discharge/charge cycle at C/20 (see FIG. 7 discussed herein for the voltage profiles), but lost over 90% of cell capacity with the second discharge cycle. Capacity losses were always seen following delithiation of LTO (plating of lithium)—there were not significant losses following the lithiation of LTO (stripping of lithium) discharge cycle. Note that the thickness of lithium was doubled in Li/LTO cells to compensate for the initial discharge/lithiation reaction of LTO, as opposed to initial charge/delithiation reaction in Li/LCO cells (e.g.; LCO starts on charge and thus there is more total lithium available for charge/discharge in a LCO vs. LTO electrode of equal capacity paired with an equivalent lithium metal anode). While it was surprising that the extra lithium metal thickness did not accommodate additional cycling for the LTO sintered electrode, again we suspect that the significant thickness change of the lithium metal electrode with cycling and additional SEI formation on the lithium during the extensive plating and stripping facilitated the dramatic capacity loss in the cell after the first charge/discharge cycle.

FIG. 7 graphically illustrates the first charge/discharge cycle for a Li/LTO cell with both sintered and composite LTO electrodes. Note that the sintered electrode cell was the same as that used for FIG. 4B as discussed herein. The first discharge cycle of the sintered electrode has a capacity of 119 mAh g⁻¹ LTO compared to 172 mAh g⁻¹ LTO for the composite electrode. The sintered LTO electrode also had more polarization on charge and discharge than a conventional composite electrode, reflecting relatively higher resistance both of the LTO sintered electrode relative to the composite electrode and the limitations of Li anodes at the total current densities and capacities for the sintered electrode LTO cell (1.10 mA cm⁻² and 20 mAh total cell capacity for discharge).

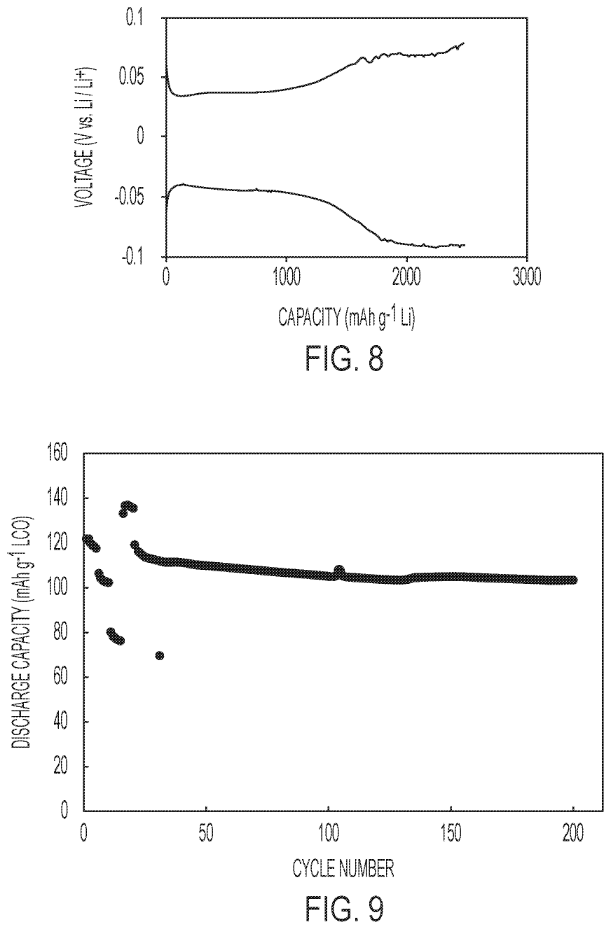

To further confirm the limitations of the lithium metal electrode in these high capacity cells, Li/Li symmetric cells were constructed using lithium foils with thickness of 200 □m (two 100 □m Li foils pressed together for each electrode) and electrode areas of 1.60 cm². The Li/Li symmetric cell was unable to complete full 20 hour cycles at current densities of ˜1.1 mA cm⁻², which corresponded to the current density used for C/20 cycling for the sintered electrodes, without hitting the 1.0 V upper voltage cutoff. To demonstrate cycling of the Li/Li cell, a current density of 0.53 mA cm⁻² (˜C/50 for sintered electrodes) was used and each cycle was set with a 50 hour time cutoff for charge/discharge (FIG. 4C). Only three full “charge” and “discharge” cycles were achieved before loss of capacity in the Li/Li cell (charge and discharge in the symmetric cell refers to a switch in the electrode that was undergoing stripping or plating). While only the first eight discharge cycle data points are shown in FIG. 4C, there was negligible capacity delivered in the cell after the 8^{th} cycle. The relatively large fraction of lithium metal stripped and plated with each cycle (˜70% of the initial lithium metal in the cell) would lead to significant SEI formation and loss of electrochemically accessible lithium in the cell. A voltage profile of the Li/Li cell is available in FIG. 8. While at 0.53 mA cm⁻² there was polarization in the Li/Li cell that increased as a function of time both on charge and discharge, cycling at higher rates of ˜1.1 mA cm⁻² to ˜4.4 mA cm⁻² (corresponding to C/20 and C/5 for the sintered electrodes) resulted in very high polarization and the cell reaching the voltage cutoff of 1.0 V. The inability of the lithium metal to cycle at current densities that for the sintered electrodes corresponded to a rate of C/20 or higher presented a challenge in attempting to determine rate capability of the sintered electrode materials when paired with dense thin film lithium metal anodes.

FIG. 8 graphically illustrates the second charge/discharge cycle for a Li/Li symmetric cell cycled at a rate of 0.53 mA cm⁻². This cell was the same as that used to provide the data for FIG. 4C in the main text. The total current density and total current for the Li/Li cell were the same as the lowest rates used in evaluation of the sintered electrode cells (˜C/50 for the sintered electrodes), and thus the time limit on the charge and discharge were limited to 50 hours. The time limit was reached for both charge and discharge. Higher rates (e.g.; >1.0 mA cm⁻²) for Li/Li coin cells resulted in increased polarization and a fluctuating voltage profile that reached the 1.0 V voltage cutoff on the first charge/discharge cycle and stopped cycling.

### Sintered Electrode Full Cells

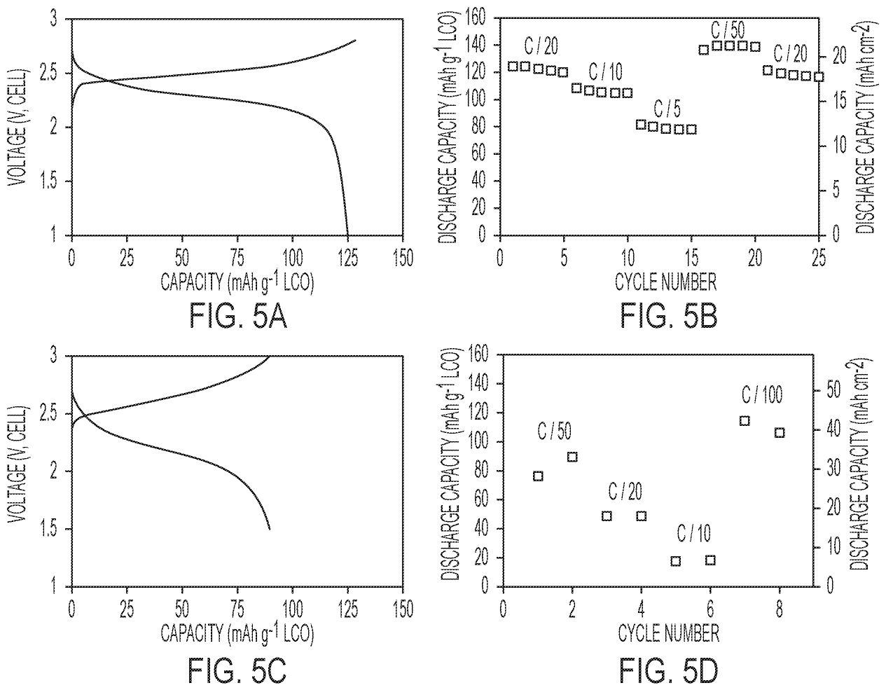

Due to the cycle life, capacity, and rate limitations of both the LCO and LTO sintered electrodes when paired with lithium metal, full cells were constructed to characterize the electrochemical performance of these electrodes without the use of lithium metal. LTO/LCO sintered electrode full cells of two different thicknesses were assembled and underwent galvanostatic cycling at various rates shown in FIG. 5. The difference between the data in FIG. 5A, 5B and FIG. 5C, 5D was the thickness and total amount of active material in the cell. The cell that provided the profiles and delivered capacities in FIG. 5C, 5D contained significantly thicker electrodes, although the particles used to fabricate the electrodes and the sintering conditions were identical to the cell with thinner electrodes.

The cell shown in FIG. 5A, 5B contained an LTO sintered electrode which was 0.75 mm thick and an LCO sintered electrode which was 0.44 mm thick, for a total thickness for the electrodes and the separator of 1.21 mm. The LTO/LCO full cell achieved a capacity of 12.5 mAh cm⁻² at the high current density of 4.62 mA cm⁻², and a capacity of 21.4 mAh cm⁻² at the lowest evaluated current density of 0.462 mA cm⁻². The full cell was designed to be cathode limited in capacity and the LCO active material loading was 153 mg cm⁻²—around six times higher than typical heavily loaded commercial composite electrodes.[2, 18] Although the cell was designed to be cathode limited, this was based on the capacity of the active materials when evaluated in composite electrodes, and because the Li/LTO sintered electrode was difficult to evaluate it is noted that it was possible that the sintered LTO electrode limited the discharge capacity in the cell. Detailed investigations determining the rate capability limitations of the LTO/LCO cells will be the subject of future investigations, but the thickness of these electrodes likely leads to significant concentration polarization and Li⁺ diffusion limitations within the porous active material matrix, thus improvement of rate capability of these electrodes will require careful design of the constituent particles, the Li⁺ diffusion pathways, and the total electrode thickness.[26] Scanning electron micrographs of the films are available in FIG. 6. FIG. 6 contains SEMs of sintered electrode thin films of LCO and LTO at high magnification (FIG. 6A, 6B) to show the morphology of the particles that comprise the film and lower magnification (FIG. 6C, 6D) to show the relatively flat and uniform electrode at a more macroscopic length scale. The sintering provided interparticle connections that enable both electronic conduction through the electrode and mechanical strength necessary for cell fabrication and withstanding the pressure that holds the coin cell electrodes in contact with current collectors. The average thickness of the LCO electrodes, including those used for electrochemical cycling in the main text in FIG. 3, FIG. 4A, and FIG. 5A, 5B was 439±16 μm, and the electrodes had a solids volume of 67.9%. The average thickness of the LTO electrodes, including those used for electrochemical cycling in the main text and Supplementary Material in FIG. 4B, FIG. 5A, 5B, and FIG. 7A, was 750±8 μm with a solids volume of 62.0%. Standard deviations were determined from three measurements on each of three different electrodes. The electrochemical cell with thicker electrodes used for the data shown in FIG. 5C, 5D in the main text had an LCO electrode with thickness 1076 μm and LTO electrode with thickness 1790 μm (single thickness measurements taken on the center of each pellet).

FIG. 6 illustrates SEM micrographic depictions of sintered electrode thin films of LCO and LTO at high magnification (FIG. 6A, 6B) to show the morphology of the particles that comprise the film and lower magnification (FIG. 6C, 6D) to show the relatively flat and uniform electrode at a more macroscopic length scale. The sintering provided interparticle connections that enable both electronic conduction through the electrode and mechanical strength necessary for cell fabrication and withstanding the pressure that holds the coin cell electrodes in contact with current collectors. The average thickness of the LCO electrodes, including those used for electrochemical cycling in the main text in FIG. 3, FIG. 4, and FIG. 5A, 5B was 439±16 μm, and the electrodes had a solids volume of 67.9%. The average thickness of the LTO electrodes, including those used for electrochemical cycling in the discussion regarding FIG. 4B, FIG. 5A, 5B, and FIG. 7A, was 750±8 μm with a solids volume of 62.0%. Standard deviations were determined from three measurements on each of three different electrodes. The electrochemical cell with thicker electrodes used for the data shown in FIG. 5C, 5D discussed herein had an LCO electrode with thickness 1076 μm and LTO electrode with thickness 1790 μm (single thickness measurements taken on the center of each pellet).

To determine the electrochemical performance of much thicker sintered electrodes, a 2032-type coin cell was assembled with 2.90 mm total electrode and separator thickness (FIG. 5C, 5D). This combined thickness for the electrodes and separator was at the limit of what the 2032-type cell could accommodate. In order to fit the 1.08 mm thick LCO and 1.79 mm thick LTO electrodes, it was necessary to remove the spacers and wave spring, with the cell crimping providing the pressure in the cell which kept the electrodes in contact with the cell casing that provided the function of the current collectors. A relatively high voltage cutoff of 3.0 V (cell, vs. LTO anode) was used to extract additional capacity relative to the other LTO/LCO sintered electrode full cells, although such a high potential for LTO/LCO cells negatively impacts capacity retention. As graphically illustrated in FIG. 5D, the cell delivered comparable gravimetric capacity on an LCO material basis to the 1.21 mm total thickness cell at low current densities. The theoretical capacity for the 2.90 mm thick cell was 109 mAh (based on 150 mAh g⁻¹ LCO), and the highest discharge capacity achieved was 83.4 mAh at 1.28 mA cm⁻² (C/100, the slowest rate used). With some optimization, a capacity of 120 mAh could reasonably be achieved in this cell geometry at the slower rates typical of many coin cell applications, and with an average voltage of around 2.5 V this design compares favorably in energy density to rechargeable commercial coin cells such as ML2032 cells with approximately 2.5 V operating voltage and 65 mAh nominal capacity.[27] Furthermore, the cell still provides significant capacity even at a constant current discharge as high as 12.8 mA constant current, corresponding to the nominal C/10 discharge graphically shown in FIG. 5D.

The capacity retention and rate capability of the 1.21 mm LTO/LCO full cell was greater than that of either the Li/LCO or Li/LTO cells, providing additional evidence that cycling and rate capability limitations in the Li/LTO and Li/LCO cells were likely due to the lithium metal electrodes rather than the sintered electrodes. The 1.21 mm thick cell retained 90.6% after 50 cycles and 85.3% after 200 cycles relative to the first cycle discharge capacity (see FIG. 9 and related discussion). Sintered electrodes have a unique reliance on small interparticle connections for connectivity and electronic conductivity. Due to the well-known issue of lithium intercalation and deintercalation causing strain and pulverization of active materials, it is expected that sintered electrodes will likely be more vulnerable than composites to intercalation pulverization. The low strain and high anode-side voltage of LTO make it one of the most durable Li-ion materials in composite cells, and it is expected that these properties are just as important for the sintered electrode architecture. The mechanisms of capacity loss in sintered electrodes will be a topic for future studies; however, the results presented here demonstrate that high energy densities are made possible by using sintered electrodes comprised of only Li-ion battery active material as cell anodes and cathodes. FIG. 9 graphically illustrates extended cycling at C/20 of the 1.21 mm thick cell after the rate capability test used for the data shown in FIG. 5A, 5B and discussion. After 50 cycles, 90.6% of the discharge capacity was retained relative to the first discharge cycle, demonstrating significant advantages in capacity retention compared to Li/LTO or Li/LCO cells. At 200 cycles, the discharge capacity retention relative to the first discharge cycle was 85.3%.

### Conclusions

Li/LCO, Li/LTO, and LTO/LCO cells with thick and dense sintered electrodes have been fabricated and characterized through galvanostatic cycling. The cells containing lithium metal anodes have very high energy density; however, the cycle life of those cells was limited to as little as 1 charge/discharge cycle for Li/LTO, and these cycle life limitations were attributed to the lithium metal anode's inability to accommodate the high current densities and total capacities that result from using thick sintered electrodes. LTO/LCO full cells were assembled that had improved cycle life and rate capability relative to Li/LCO and Li/LTO cells, demonstrating that the short cycle life of the half cells was likely due to the deep cycling of lithium as opposed to pulverization of interparticle connections and loss of electronic conductivity and cohesion from the sintered electrodes. Additionally, reversible electrochemical cycling was demonstrated in a cell containing sintered electrodes for both the anode and cathode and a total electrode and separator thickness up to 2.90 mm, resulting in extremely high areal loadings and areal capacities. Further efforts will be needed to probe capacity loss mechanisms within sintered electrode films, as well as further optimization of the sintered electrode particle constituents and microstructures to improve these unique battery electrode materials.

### Preparation of Active Material Powders

LCO was synthesized using an adapted method previously reported in the literature.[28] First, CoC₂O₄.2H₂O precipitate particles were synthesized by pouring all at once an 1800 mL solution of 62.8 mM Co(NO₃)₂.6H₂O (Fisher Reagent Grade) dissolved in deionized (DI) water into an 1800 mL solution of 87.9 mM (NH₄)₂C₂O₄.H₂O (Fisher Certified ACS) dissolved in DI water. Solutions were preheated to 50° C. prior to mixing and the temperature was maintained at 50° C. for the duration of the synthesis. The solution was stirred continuously and vigorously at 800 rpm with a magnetic stirrer. After 30 minutes of precipitation, CoCO₄.2H₂O particles were collected via vacuum filtration, rinsed with 4 L of DI water, and vacuum dried overnight at 80° C. CoC₂O₄.2H₂O powder was mixed with Li₂CO₃ (Fisher Certified ACS) powder with 2% excess Li salt relative to stoichiometric quantities (e.g.; Li:Co mixed at 1.02:1 molar ratio) in a mortar and pestle. The mixed powder was fired at a 1° C. per minute ramp rate to 800° C. with no hold time in a Carbolite CWF 1300 box furnace in air, and upon reaching 800° C. the furnace was turned off and allowed to cool to ambient temperature without control over cooling rate. After firing, the resulting LCO powder was milled in a Fritsch Pulverisette 7 planetary ball mill with 5 mm diameter zirconia beads for 5 hours at 300 rpm.

The LTO powder used was NANOMYTE BE-10 purchased from NEI Corporation. Characterization of this material can be found in previous reports.[29]

### Electrode Preparation and Characterization

Active material powder was mixed with solution containing 1 wt % polyvinyl butyral dissolved in ethanol at a ratio of 2 mL binder solution:1 g active material powder using a mortar and pestle. After solvent evaporation by exposure to air, the active material and binder mixture was further ground in a mortar and pestle. Either 0.2 g LCO-binder mixture or 0.22 g LTO-binder mixture were loaded into a 13 mm diameter Carver pellet die and pressed with 12,000 lb_{f} for 2 minutes in a Carver hydraulic press. A 16 mm diameter pellet die was used for the very thick LCO and LTO electrodes (FIG. 5C, 5D). After pressing, electrodes were sintered in a Carbolite CWF 1300 box furnace in air through heating to a peak temperature of 700° C. and held for 1 hour with a 1° C. per minute ramping and cooling rate. After cooling, electrodes were attached directly to stainless steel coin cell spacers using an N-methyl pyrrolidone (NMP) solvated binder slurry of 1:1 weight ratio Super P carbon black conductive additive to polyvinylidene difluoride (PVDF) binder and dried overnight in an 80° C. oven.

Composite electrodes were prepared by coating a slurry comprised of active material (for LTO directly as received, for LCO after ball milling), carbon black conductive additive, and PVDF binder in NMP solvent with a weight ratio of 80:10:10 active:carbon black:PVDF onto an aluminum foil current collector using a doctor blade with a gap of 200 μm. The electrode slurry was dried in an 80° C. oven overnight and dried in an 80° C. vacuum oven for 3 hours prior to punching out 14 mm diameter electrode disks.

Electrodes for all cells were assembled into CR2032 coin cells in an argon atmosphere glove box with a single trilayer polymer separator and an electrolyte comprised of 1.2 M LiPF₆ in 3:7 ethylene carbonate:ethyl methyl carbonate electrolyte. Cells were tested through constant current charge/discharge cycling on a MACCOR battery cycler. Where reported, C rates were based on assumed capacities of 150 mAh g⁻¹ for LCO and 175 mAh g⁻¹ for LTO (e.g., 1C for LCO electrodes was 150 mA g⁻¹ LCO). Voltage ranges and current densities used during cell cycling for different cell types (Li/LTO, Li/LCO, LTO/LCO with sintered or composite electrodes and different loadings) can be found in the text and figure captions for each cell discussed.

Example and Experimental Results Set No. 2

Thick Sinterered Electrodes with Designated Material Composition

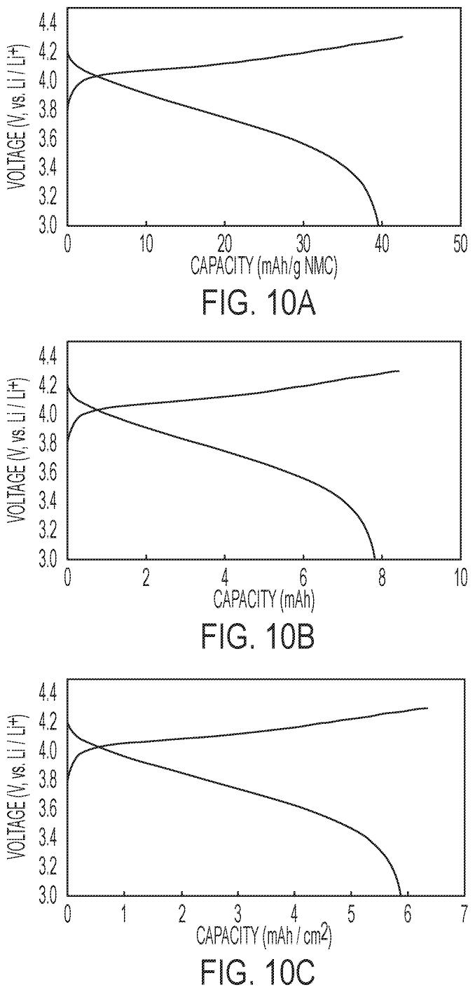

Next, FIG. 10 graphically illustrates charge/discharge profiles for LiNi_{1/3}Mn_{1/3}Ni_{1/3}O₂ (NMC) sintered electrode cathode paired with a Li metal anode in an 2032-type coin cell for the second charge/discharge cycle showing: the capacity normalized by mass of NMC in the cell (as shown in FIG. 10A); the total capacity (as shown in FIG. 10B); and the capacity normalized by the geometric area of the NMC sintered electrode (as shown in FIG. 10C);. The anode was Li metal foil and the cathode was an NMC sintered electrode. The cathode contained 0.198 g of NMC and had a geometric area of 1.3 cm². The charge and discharge currents were both the same and were 0.594 mA (current density 0.447 mA/cm²). The voltage window was 3.0 V to 4.3 V (vs. Li/Li⁺).

### Example and Experimental Results Set No. 3

### Cycling Stability of Batteries

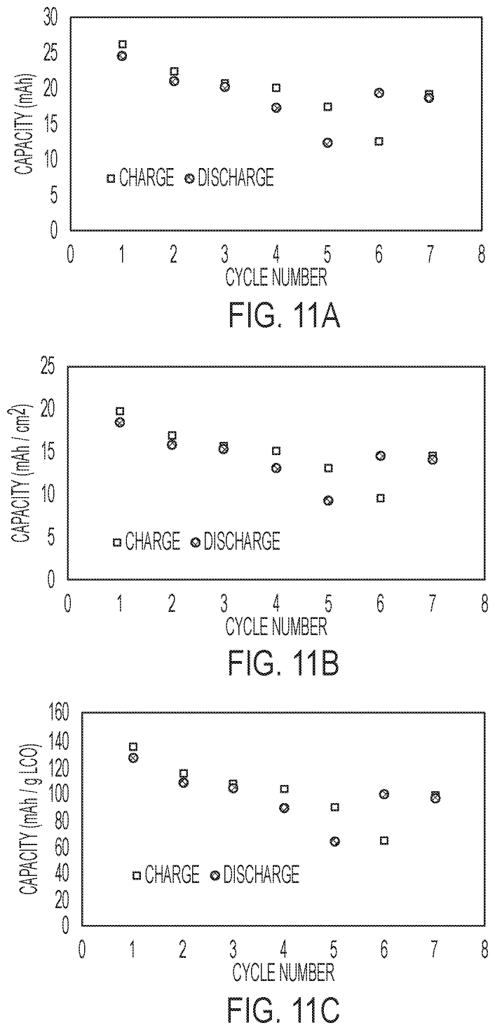

Next, FIG. 11 graphically illustrates rate capability testing on a 2032-type coin cell where both electrodes are sintered all active material electrodes with LTO anode and LCO cathode. The LCO electrode in the coin cell was sintered at 600° C. The capacity is given in: an absolute basis (as shown in FIG. 11A); an electrode area basis (as shown in FIG. 11B); and a gravimetric basis (as shown in FIG. 11C) using only the mass of the LCO active material in the cell. The current used for cycle one was 0.292 mA (0.22 mA/cm², ˜C/100) for both charge and discharge. For cycles 2-7, the charging current was 1.46 mA (1.10 mA/cm², ˜C/15). The discharge current was varied for cycles 2-7, with a discharge current of 1.46 mA (1.10 mA/cm², ˜C/15) for cycles 2, 3, 6, and 7, a discharge current of 2.93 mA (2.20 mA/cm², ˜C/6) for cycle 4, and a discharge current of 5.85 mA (4.40 mA/cm², ˜C/2) for cycle 6. The voltage window used for cycling was 1.0-2.8 V (cell voltage).

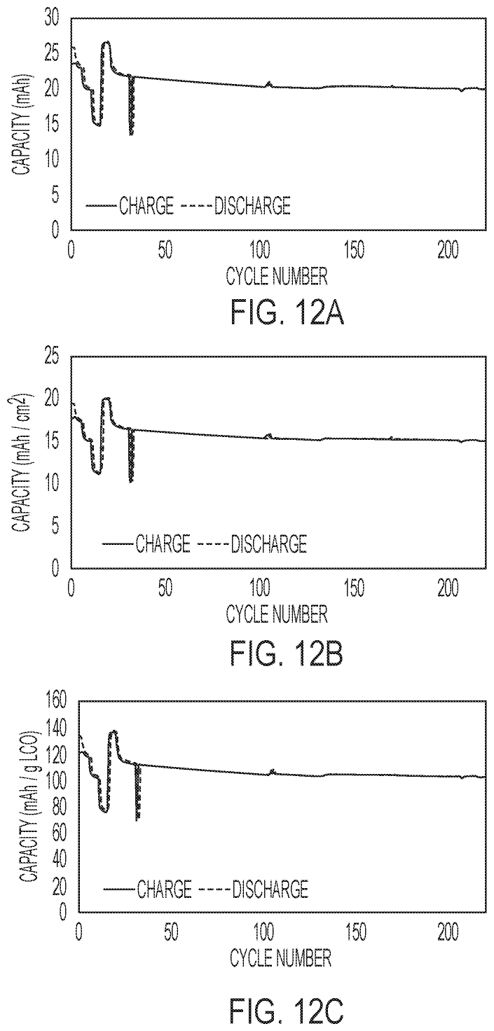

Additionally, FIG. 12 graphically illustrates rate capability testing on a 2032-type coin cell followed by cycle life testing where both electrodes are sintered all active material electrodes with LTO anode and LCO cathode. The LCO electrode in the coin cell was sintered at 700° C. The capacity is given in: an absolute basis (as shown in FIG. 12A); an electrode area basis (as shown in FIG. 12B); and a gravimetric basis (as shown in FIG. 12C); using only the mass of the LCO active material in the cell. The current used for cycles 1-5 was 1.46 mA (1.10 mA/cm², ˜C/15) for both charge and discharge. For cycles 6-10, the charging current was 1.46 mA (1.10 mA/cm², ˜C/15) and the discharge current was 2.93 mA (2.20 mA/cm², ˜C/6). For cycles 11-15 the charging current was 1.46 mA (1.10 mA/cm², ˜C/15) and the discharge current was 5.85 mA (4.40 mA/cm², ˜C/2). For cycles 16-20, both the charge and discharge current was 0.585 mA (0.44 mA/cm², ˜C/50). For cycles 21-220, both the charge and discharge current used was 1.46 mA (1.10 mA/cm², ˜C/15). The voltage window used for cycling was 1.0-2.8 V (cell voltage).

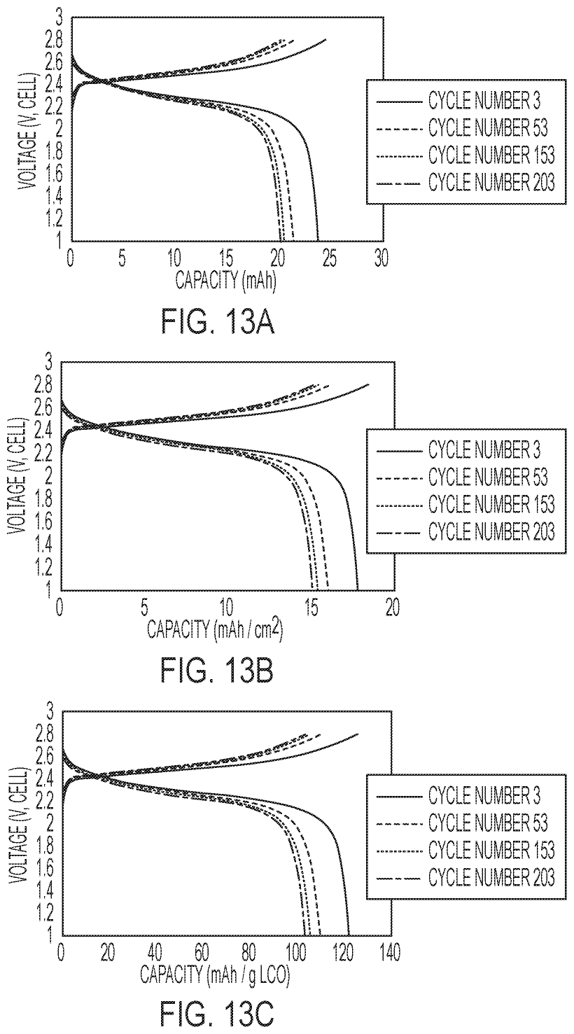

Moreover, FIG. 13 graphically illustrates charge/discharge voltage profiles for the same cell from FIG. 12 from cycle number 3 (solid line), 53 (dashed line), 153 (dotted line), and 203 (short dash-long dash line). The current used for both charge and discharge for all voltage profiles shown was 1.46 mA (1.10 mA/cm², ˜C/15). The voltage window used for cycling was 1.0-2.8 V (cell voltage). The voltage profiles are shown using: an absolute basis (as shown in FIG. 13A); an electrode area basis (as shown in FIG. 13B); and a gravimetric basis (as shown in FIG. 13C); using only the mass of the LCO active material in the cell.

### Example and Experimental Results Set No. 4

### Storage Life of Batteries

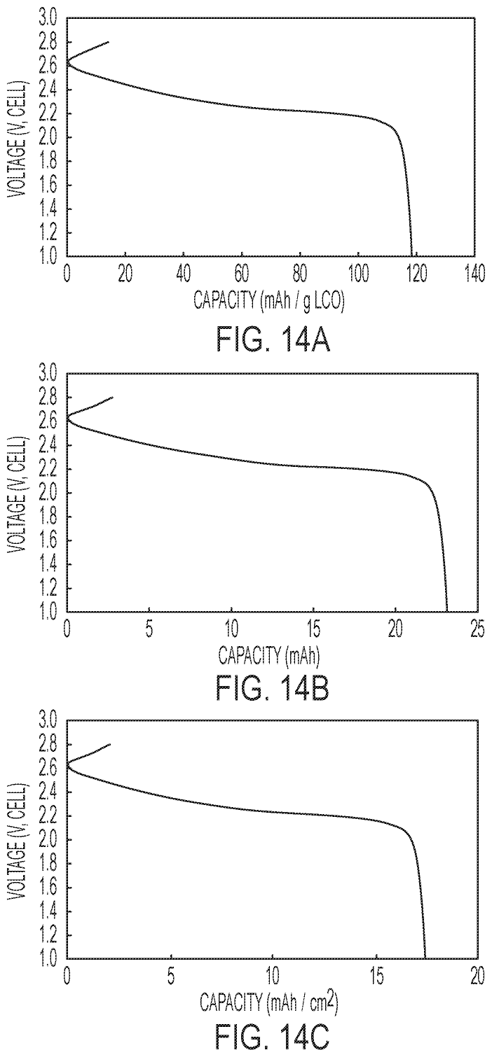

Next, FIG. 14 graphically illustrates charge/discharge profiles on: a mass of LCO basis (as shown in FIG. 14A); a total capacity basis (as shown in FIG. 14B); and an areal capacity basis (as shown in FIG. 14C) after 7 months of storage for an LTO/LCO cell where both the anode and cathode were porous sintered electrodes. The cell was initially charged to 2.8 V at a rate of 0.293 mA (0.220 mA/cm², or ˜C/100). The cell was stored for 7 months at room temperature, after which it was charged at 0.293 mA (0.220 mA/cm², or ˜C/100) until reaching 2.8 V, and then discharged at 0.293 mA (0.220 mA/cm², or ˜C/100) to a cutoff voltage of 1.0 V. The additional charge capacity after storage was 2.70 mAh (13.85 mAh/g LCO, 2.03 mAh/cm²) and the discharge capacity was 23.13 mAh (118.64 mAh/g LCO, 17.39 mAh/cm²). This indicates that 2.7/23.13*100=11.67% capacity was lost during the storage, equivalent to a self-discharge rate of 1.67% of capacity per month.

### Additional Examples

### Example 1

An electrochemical device comprising:

an anode electrode comprised of porous spaces and only sintered active material, in electronic communication with an anode current collector;

a cathode electrode comprised of porous spaces and only sintered active material, in electronic communication with a cathode current collector;

a separator comprised of channels, disposed between said anode electrode and said cathode electrode; and

an electrolyte in ionic contact with said anode electrode, said cathode electrode, and said separator, and which also fills said porous spaces within the anode electrode and cathode electrode.

### Example 2

The device of example 1, further comprising:

an anode buffer structure disposed between said anode current collector and said anode electrode;

a cathode buffer structure disposed between said cathode current collector and said cathode electrode; or

an anode buffer structure disposed between said anode current collector and said anode electrode and a cathode buffer structure disposed between said cathode current collector and said cathode electrode.

### Example 3

The device of example 2 (as well as subject matter in whole or in part of example 1), wherein either said anode buffer structure or said cathode buffer structure or both of said anode buffer structure and said cathode buffer structure are comprised of a:

battery binder material;

conductive additive material; or

battery binder material and conductive material.

### Example 4

The device of example 3 (as well as subject matter of one or more of any combination of examples 1 or 2, in whole or in part), wherein said battery binder material is at least one of any combination of the following:

polyvinylidene difluoride (PVDF); styrene butadiene rubber (SBR), carboxymethyl cellulose (CMC), or polyacrylonitrile.

### Example 5

The device of example (as well as subject matter of one or more of any combination of examples 1, 2 or 4, in whole or in part), wherein said conductive additive material is at least one of any combination of the following: carbon black, graphite, carbon nanotubes, or graphene.

### Example 6

The device of example 1 (as well as subject matter of one or more of any combination of examples 2-5, in whole or in part), wherein said ionic contact includes said electrolyte dispersed within said channels of said separator.

### Example 7

The device of example 1 (as well as subject matter of one or more of any combination of examples 2-6, in whole or in part), wherein said separator itself provides ionic conductive contact if said separator is solid state electrolyte type or polymer electrolyte type.

### Example 8

The device of example 1 (as well as subject matter of one or more of any combination of examples 2-7, in whole or in part), wherein the thickness of said anode electrode is about 400 μm (i.e., about 4 mm).

### Example 9

The device of example 1 (as well as subject matter of one or more of any combination of examples 2-8, in whole or in part), wherein the thickness of said anode electrode is in the range of the following ranges:

about 100 μm to about 1,000 μm (i.e., between about 0.1 mm and about 1 mm);

about 150 μm to about 400 μm (i.e., between about 0.15 mm and about 0.4 mm);

about 250 μm to about 800 μm (i.e., between about 0.25 mm and about 0.8 mm);

about270 μm to about 800 μm (i.e., between about 0.27 mm and about 0.8 mm);

about 350 μm to about 500 μm (i.e., between about 0.35 mm and about 0.5 mm);

about 300 μm to about 800 μm (i.e., between about 0.3 mm and about 0.8 mm);

about 350 μm to about 400 μm (i.e., between about 0.35 mm and about 0.4 mm);

about 400 μm to about 800 μm (i.e., between about 0.4 mm and about 0.8 mm);

about 450 μm to about 600 μm (i.e., between about 0.45 mm and about 0.6 mm);

about 500 μm to about 800 μm (i.e., between about 0.5 mm and about 0.8 mm);

about 800 μm to about 1,000 μm (i.e., between about 0.8 mm and about 1 mm);

about 200 μm to about 2,000 μm (i.e., between about 0.2 mm and about 2 mm);

about 250 μm to about 2,000 μm (i.e., between about 0.25 mm and about 2 mm);

about 270 μm to about 2,000 μm (i.e., between about 0.27 mm and about 2 mm);

about 300 μm to about 2,000 μm (i.e., between about 0.3 mm and about 2 mm);

about 1,000 μm to about 5,000 μm (i.e., between about 1 mm and about 5 mm);

about 1,000 μm to about 2,500 μm (i.e., between about 1 mm and about 2.5 mm);

about 2,500 μm to about 5,000 μm (i.e., between about 2.5 mm and about 5 mm);

about 4,000 μm to about 5,000 μm (i.e., between about 4 mm and about 5 mm); or

about 100 μm to about 5,000 μm (i.e., between about 0.1 mm and about 5 mm).

### Example 10

The device of example 1 (as well as subject matter of one or more of any combination of examples 2-9, in whole or in part), wherein the thickness of said cathode electrode is about 400 μm (i.e., about 4 mm).

### Example 11

The device of example 1 (as well as subject matter of one or more of any combination of examples 2-10, in whole or in part), wherein the thickness of said cathode electrode is in the range of the following ranges:

about 100 μm to about 1,000 μm (i.e., between about 0.1 mm and about 1 mm);

about 150 μm to about 400 μm (i.e., between about 0.15 mm and about 0.4 mm);

about 250 μm to about 800 μm (i.e., between about 0.25 mm and about 0.8 mm);

about 270 μm to about 800 μm (i.e., between about 0.27 mm and about 0.8 mm);

about 350 μm to about 500 μm (i.e., between about 0.35 mm and about 0.5 mm);

about 300 μm to about 800 μm (i.e., between about 0.3 mm and about 0.8 mm);

about 350 μm to about 400 μm (i.e., between about 0.35 mm and about 0.4 mm);

about 400 μm to about 800 μm (i.e., between about 0.4 mm and about 0.8 mm);

about 450 μm to about 600 μm (i.e., between about 0.45 mm and about 0.6 mm);

about 500 μm to about 800 μm (i.e., between about 0.5 mm and about 0.8 mm);

about 800 μm to about 1,000 μm (i.e., between about 0.8 mm and about 1 mm);

about 200 μm to about 2,000 μm (i.e., between about 0.2 mm and about 2 mm);

about 250 μm to about 2,000 μm (i.e., between about 0.25 mm and about 2 mm);

about 270 μm to about 2,000 μm (i.e., between about 0.27 mm and about 2 mm);

about 300 μm to about 2,000 μm (i.e., between about 0.3 mm and about 2 mm);

about 1,000 μm to about 5,000 μm (i.e., between about 1 mm and about 5 mm);

about 1,000 μm to about 2,500 μm (i.e., between about 1 mm and about 2.5 mm);

about 2,500 μm to about 5,000 μm (i.e., between about 2.5 mm and about 5 mm);

about 4,000 μm to about 5,000 μm (i.e., between about 4 mm and about 5 mm); or

about 100 μm to about 5,000 μm (i.e., between about 0.1 mm and about 5 mm).

### Example 12

The device of example 1 (as well as subject matter of one or more of any combination of examples 2-11, in whole or in part), wherein said anode current collector and/or said cathode current collector are in the shape of a frame or border.

### Example 13

The device of example 1 (as well as subject matter of one or more of any combination of examples 2-12, in whole or in part), wherein said respective active material of each said anode electrode and said cathode electrode comprises any combination of at least one or more of the following:

Li metal anode and Li₄Ti₅O₁₂ cathode;

Li metal anode and LiN₂O₄ cathode,
where N can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiMO₂ cathode,
where M can be:
   any transition metal in isolation or combination of multiple transition metals,
   Al in isolation or in combination of one or more transition metals, or any alkali metal in isolation or combination of multiple alkali metals;

Li₄Ti₅O₁₂ anode and LiM₂O₄ cathode,
where M can be:
   any transition metal in isolation or combination of multiple transition metals, Al in isolation or in combination of one or more transition metals, or
   any alkali metal in isolation or combination of multiple alkali metals;

LiN₂O₄ anode and LiM₂O₄ cathode,
where N can be:
   any transition metal in isolation or combination of multiple transition metals,
   Al in isolation or in combination of one or more transition metals, or
   any alkali metal in isolation or combination of multiple alkali metals, and
where M can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiNiₓMn_{y}Co_{z}O₂ cathode;
where x+y+z=1;

LiN₂O₄ anode and LiNiₓMn_{y}Co_{z}O₂ cathode;
where N can be:
   any transition metal in isolation or combination of multiple transition metals,
   Al in isolation or in combination of one or more transition metals,
   any alkali metal in isolation or combination of multiple alkali metals,
and
where x+y+z=1;

Li metal anode and LiMO₂ cathode, where M can be:
any transition metal in isolation or combination of multiple transition metals,
Al in isolation or in combination of one or more transition metals, or
any alkali metal in isolation or combination of multiple alkali metals; or

Li metal anode and LiM₂O₄ cathode, where M can be:
any transition metal in isolation or combination of multiple transition metals,
Al in isolation or in combination of one or more transition metals, or
any alkali metal in isolation or combination of multiple alkali metals.

### Example 14

The device of example 1 (as well as subject matter of one or more of any combination of examples 2-13, in whole or in part), wherein said respective active material of each said anode electrode and said cathode electrode comprises any combination of at least one or more of the following:

Na metal anode and Na₄Ti₅O₁₂ cathode;

K metal anode and K₄Ti₅O₁₂ cathode;

Na metal anode and NaMO₂ cathode, where M can be:
any transition metal in isolation or combination of multiple transition metals,
Al in isolation or in combination of one or more transition metals, or
any alkali metal in isolation or combination of multiple alkali metals;

K metal anode and KMO₂ cathode, where M can be:
any transition metal in isolation or combination of multiple transition metals,
Al in isolation or in combination of one or more transition metals, or
any alkali metal in isolation or combination of multiple alkali metals;

Na metal anode and NaM₂O₄ cathode, where M can be:
any transition metal in isolation or combination of multiple transition metals,
Al in isolation or in combination of one or more transition metals, or
any alkali metal in isolation or combination of multiple alkali metals;

K metal anode and KM₂O₄ cathode, where M can be:
any transition metal in isolation or combination of multiple transition metals,
Al in isolation or in combination of one or more transition metals, or
any alkali metal in isolation or combination of multiple alkali metals;

Na₄Ti₅O₁₂ anode and NaMO₂ or NaM₂O₄ cathode, where M can be:
any transition metal in isolation or combination of multiple transition metals,
Al in isolation or in combination of one or more transition metals, or
any alkali metal in isolation or combination of multiple alkali metals;

or

K₄Ti₅O₁₂ anode and KMO₂ or KM₂O₄ cathode, where M can be:
any transition metal in isolation or combination of multiple transition metals,
Al in isolation or in combination of one or more transition metals, or
any alkali metal in isolation or combination of multiple alkali metals.

### Example 15

The device of example 1 (as well as subject matter of one or more of any combination of examples 2-14, in whole or in part), wherein:

said anode current collector is configured to be in communication with an external circuit;

said cathode current collector is configured to be in communication with an external circuit; or

said anode current collector is configured to be in communication with an external circuit and said cathode current collector is configured to be in communication with an external circuit.

16. The device of example 1 (as well as subject matter of one or more of any combination of examples 2-15, in whole or in part), wherein said anode electrode is free of: battery binder material, conductive additive material, or battery binder material and conductive additive material.

### Example 17

The device of example 1 (as well as subject matter of one or more of any combination of examples 2-16, in whole or in part), wherein said cathode electrode is free of: battery binder material, conductive additive material, or battery binder material and conductive additive material.

### Example 18

The device of example 1 (as well as subject matter of one or more of any combination of examples 2-17, in whole or in part), wherein said anode electrode is further configured with a coating disposed on the exterior so as to be an integrated, operable portion of said anode electrode.

### Example 19

The device of example 1 (as well as subject matter of one or more of any combination of examples 2-18, in whole or in part), wherein said cathode electrode is further configured with a coating disposed on the exterior so as to be an integrated, operable portion of said cathode electrode.

### Example 20

The device of example 1 (as well as subject matter of one or more of any combination of examples 2-19, in whole or in part), wherein said active material of said anode electrode is about 60 percent solid by volume fraction.

### Example 21

The device of example 1 (as well as subject matter of one or more of any combination of examples 2-20, in whole or in part), wherein said active material of said anode electrode is in the range of the following ranges:

about 35 percent solid by volume fraction to about 60 percent solid by volume fraction;

about 45 percent solid by volume fraction to about 70 percent solid by volume fraction;

about 60 percent solid by volume fraction to about 70 percent solid by volume fraction;

about 35 percent solid by volume fraction to about 80 percent solid by volume fraction;

about 65 percent solid by volume fraction to about 70 percent solid by volume fraction;

about 65 percent solid by volume fraction to about 75 percent solid by volume fraction;

about 70 percent solid by volume fraction to about 75 percent solid by volume fraction; or

about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 or 80 percent solid by volume fraction.

### Example 22

The device of example 1 (as well as subject matter of one or more of any combination of examples 2-21, in whole or in part), wherein said active material of said cathode electrode is about 60 percent solid by volume fraction.

### Example 23

The device of example 1 (as well as subject matter of one or more of any combination of examples 2-22, in whole or in part), wherein said active material of said cathode electrode is in the range of the following ranges:

about 35 percent solid by volume fraction to about 60 percent solid by volume fraction.

about 45 percent solid by volume fraction to about 70 percent solid by volume fraction;

about 60 percent solid by volume fraction to about 70 percent solid by volume fraction;

about 35 percent solid by volume fraction to about 80 percent solid by volume fraction;

about 65 percent solid by volume fraction to about 70 percent solid by volume fraction;

about 65 percent solid by volume fraction to about 75 percent solid by volume fraction;

about 70 percent solid by volume fraction to about 75 percent solid by volume fraction; or

about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 or 80 percent solid by volume fraction.

### Example 24

The device of example 1 (as well as subject matter of one or more of any combination of examples 2-23, in whole or in part), wherein said anode electrode and cathode electrode performs at one of the following:

electrode areal capacity of about 45 mAh/cm² and current density of about 1.28 mA/cm²;

electrode areal capacity of about 33 mAh/cm² and current density of about 2.56 mA/cm²;

electrode areal capacity of about 20 mAh/cm² and current density of about 6.4 mA/cm²; or

electrode areal capacity of about 8 mAh/cm² and current density of about 12.8 mA/cm².

### Example 25

The device of example 1 (as well as subject matter of one or more of any combination of examples 2-24, in whole or in part), wherein said anode electrode and cathode electrode performs at one of the following:

electrode areal capacity of about 18 mAh/cm² and current density of about 1.848 mA/cm²;

electrode areal capacity of about 16 mAh/cm² and current density of about 3.696 mA/cm²;

electrode areal capacity of about 12.5 mAh/cm² and current density of about 4.62 mA/cm²; or

electrode areal capacity of about 21.4 mAh/cm² and current density of about 0.462 mA/cm².

### Example 26

The device of example 1 (as well as subject matter of one or more of any combination of examples 2-25, in whole or in part), wherein said anode electrode and cathode electrode performs at electrode areal capacity at one of the following:

about 10 mAh/cm²;

about 15 mAh/cm²;

about 25 mAh/cm²;

about 35 mAh/cm²;

about 50 mAh/cm²;

about 65 mAh/cm²;

about 75 mAh/cm²;

about 80 mAh/cm²;

about 90 mAh/cm²; or

a range of about 10 mAh/cm² through about 90 mAh/cm².

### Example 27

The device of example 1 (as well as subject matter of one or more of any combination of examples 2-26, in whole or in part), wherein said anode electrode and cathode electrode performs at a current density at one of the following:

about 0.1 mA/cm²;

about 0.25 mA/cm²;

about 0.50 mA/cm²;

about 0.75 mA/cm²;

about 1.0 mA/cm²;

about 2.5 mA/cm²;

about 5.0 mA/cm²;

about 7.5 mA/cm²;

about 10.0 mA/cm²;

about 12.50 mA/cm²;

about 15.0 mA/cm²;

about 17.50 mA/cm²;

about 20.0 mA/cm²; or

a range of about 0.1 mA/cm² through about 20.0 mA/cm².

### Example 28

The device of example 1 (as well as subject matter of one or more of any combination of examples 2-27, in whole or in part), further comprising a cell casing configured to at least partially enclose said device.

### Example 29

The device of example 1 (as well as subject matter of one or more of any combination of examples 2-28, in whole or in part), wherein the device is provided in at least one of the following configurations:

button cell, coin cell, pouch cell, prismatic cell, flat cell, cylindrical cell, thin film cell, sealed cell, or wound cell.

### Example 30

A method of making an electrochemical device, whereby the method may comprise the following steps (in whole or in part, as well as substitutions, additions, and omissions thereof):

synthesizing respective precursor materials, intended to respectively be used for each of a cathode electrode and an anode electrode, using coprecipitation technique;

mixing the respective synthesized precursor materials, intended to respectively be used for each of the cathode electrode and anode electrode, with lithium source and heating the mixture to provide active material particles;

milling the respective active material particles, intended to respectively be used for each of the cathode electrode and anode electrode;

coating the respective active material particles, intended to respectively be used for each of the cathode electrode and anode electrode, with a binder;

hydraulically pressing of the respective active particles into pellets, intended to respectively be used for each of the cathode electrode and anode electrode;

thermally treating the respective pellets to sinter the pellets, intended to respectively be used for each of the cathode electrode and anode electrode;

configuring respective sintered pellets into a sintered cathode electrode and sintered anode electrode;

applying electrically conductive buffer to a current collector (for cathode) and attach to said sintered cathode electrode;

applying the separator and adding the electrolyte to the sintered cathode electrode and separator;

applying electrically conductive buffer to a current collector (for anode) and attaching to said sintered anode electrode;

adding the electrolyte to the sintered anode electrode;

disposing a spring or compression component in communication with the sintered anode electrode; and

disposing a top cap or case in communication to the spring or compression component to provide a device in an assembled configuration;

### Example 31

The method of example 30, further comprising the following step:

crimping or sealing the assembled device.

### Example 32

The method of example 31, further comprising the following step: electrochemically cycling the device a predetermined number of times.

### Example 33

The method of example 31 (as well as subject matter of one or more of any combination of examples 30 or 32, in whole or in part), wherein said sintered cathode electrode and said sintered anode electrode comprises any combination of at least one or more of the following:

Li metal anode and Li₄Ti₅O₁₂ cathode;

Li metal anode and LiN₂O₄ cathode,
where N can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiMO₂ cathode,
where M can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiM₂O₄ cathode,
where M can be:
   any transition metal in isolation or combination of multiple transition metals, Al in isolation or in combination of one or more transition metals, or
   any alkali metal in isolation or combination of multiple alkali metals;

LiN₂O₄ anode and LiM₂O₄ cathode,
where N can be:
   any transition metal in isolation or combination of multiple transition metals,
   Al in isolation or in combination of one or more transition metals, or
   any alkali metal in isolation or combination of multiple alkali metals,
and
where M can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiNiₓMn_{y}Co_{z}O₂ cathode;
where x+y+z=1;

LiN₂O₄ anode and LiNiₓMn_{y}Co_{z}O₂ cathode;
where N can be:
   any transition metal in isolation or combination of multiple transition metals,
   Al in isolation or in combination of one or more transition metals,
   any alkali metal in isolation or combination of multiple alkali metals,
and
where x+y+z=1;

Li metal anode and LiMO₂ cathode, where M can be:
any transition metal in isolation or combination of multiple transition metals,
Al in isolation or in combination of one or more transition metals, or
any alkali metal in isolation or combination of multiple alkali metals;

or

Li metal anode and LiM₂O₄ cathode, where M can be:
any transition metal in isolation or combination of multiple transition metals,
Al in isolation or in combination of one or more transition metals, or
any alkali metal in isolation or combination of multiple alkali metals.

### Example 34

The method of example 31 (as well as subject matter of one or more of any combination of examples 30, 32, and 33, in whole or in part), wherein said sintered cathode electrode and said sintered anode electrode comprises any combination of at least one or more of the following:

Na metal anode and Na₄Ti₅O₁₂ cathode;

K metal anode and K₄Ti₅O₁₂ cathode;

Na metal anode and NaMO₂ cathode, where M can be:
any transition metal in isolation or combination of multiple transition metals,
Al in isolation or in combination of one or more transition metals, or
any alkali metal in isolation or combination of multiple alkali metals;

K metal anode and KMO₂ cathode, where M can be:
any transition metal in isolation or combination of multiple transition metals,
Al in isolation or in combination of one or more transition metals, or
any alkali metal in isolation or combination of multiple alkali metals;

Na metal anode and NaM₂O₄ cathode, where M can be:
any transition metal in isolation or combination of multiple transition metals,
Al in isolation or in combination of one or more transition metals, or
any alkali metal in isolation or combination of multiple alkali metals;

K metal anode and KM₂O₄ cathode, where M can be:
any transition metal in isolation or combination of multiple transition metals,
Al in isolation or in combination of one or more transition metals, or
any alkali metal in isolation or combination of multiple alkali metals;

Na₄Ti₅O₁₂ anode and NaMO₂ or NaM₂O₄ cathode, where M can be:
any transition metal in isolation or combination of multiple transition metals,
Al in isolation or in combination of one or more transition metals, or
any alkali metal in isolation or combination of multiple alkali metals;

or

K₄Ti₅O₁₂ anode and KMO₂ or KM₂O₄ cathode, where M can be:
any transition metal in isolation or combination of multiple transition metals,
Al in isolation or in combination of one or more transition metals, or
any alkali metal in isolation or combination of multiple alkali metals.

### Example 35

A method of making an electrochemical device, whereby the method may comprising the following steps (in whole or in part, as well as substitutions, additions, and omissions thereof):

milling respective active material particles, intended to respectively be used for each of a cathode electrode and an anode electrode;

pressing of the respective active particles into pellets, intended to respectively be used for each of the cathode electrode and anode electrode;

thermally treating the respective pellets to sinter the pellets, intended to respectively be used for each of the cathode electrode and anode electrode;

configuring respective sintered pellets into a sintered cathode electrode and sintered anode electrode;

attaching a current collector (for cathode) to said sintered cathode electrode;

applying the separator and adding the electrolyte to the sintered cathode electrode and separator;

attaching a current collector (for anode) to said sintered anode electrode;

adding the electrolyte to the sintered anode electrode; and

disposing a top cap or case in communication to the current collector (for anode) to provide a device in an assembled configuration.

### Example 36

The method of example 35, further comprising the following step: crimping or sealing the assembled device.

### Example 37

The method of example 36 (as well as subject matter in whole or in part of example 35), further comprising the following step:

electrochemically cycling the device a predetermined number of times.

### Example 38

The method of example 35 (as well as subject matter of one or more of any combination of examples 36-37, in whole or in part), wherein said sintered cathode electrode and said sintered anode electrode comprises any combination of at least one or more of the following:

Li metal anode and Li₄Ti₅O₁₂ cathode;

Li metal anode and LiN₂O₄ cathode,
where N can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiMO₂ cathode,
where M can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiM₂O₄ cathode,
where M can be:
any transition metal in isolation or combination of multiple transition metals, Al in isolation or in combination of one or more transition metals, or
   any alkali metal in isolation or combination of multiple alkali metals;

LiN₂O₄ anode and LiM₂O₄ cathode,
where N can be:
   any transition metal in isolation or combination of multiple transition metals,
   Al in isolation or in combination of one or more transition metals, or
   any alkali metal in isolation or combination of multiple alkali metals,
and
where M can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiNiₓMn_{y}Co_{z}O₂ cathode;
where x+y+z=1;

LiN₂O₄ anode and LiNiₓMn_{y}Co_{z}O₂ cathode;
where N can be:
   any transition metal in isolation or combination of multiple transition metals,
   Al in isolation or in combination of one or more transition metals,
   any alkali metal in isolation or combination of multiple alkali metals,
and
where x+y+z=1;

Li metal anode and LiMO₂ cathode, where M can be:
any transition metal in isolation or combination of multiple transition metals,
Al in isolation or in combination of one or more transition metals, or
any alkali metal in isolation or combination of multiple alkali metals;

or

Li metal anode and LiM₂O₄ cathode, where M can be:
any transition metal in isolation or combination of multiple transition metals,
Al in isolation or in combination of one or more transition metals, or
any alkali metal in isolation or combination of multiple alkali metals.

### Example 39

The method of example 35 (as well as subject matter of one or more of any combination of examples 36-38, in whole or in part), wherein said sintered cathode electrode and said sintered anode electrode comprises any combination of at least one or more of the following:

Na metal anode and Na₄Ti₅O₁₂ cathode;

K metal anode and K₄Ti₅O₁₂ cathode;

Na metal anode and NaMO₂ cathode, where M can be:
any transition metal in isolation or combination of multiple transition metals,
Al in isolation or in combination of one or more transition metals, or
any alkali metal in isolation or combination of multiple alkali metals;

K metal anode and KMO₂ cathode, where M can be:
any transition metal in isolation or combination of multiple transition metals,
Al in isolation or in combination of one or more transition metals, or
any alkali metal in isolation or combination of multiple alkali metals;

Na metal anode and NaM₂O₄ cathode, where M can be:
any transition metal in isolation or combination of multiple transition metals,
Al in isolation or in combination of one or more transition metals, or
any alkali metal in isolation or combination of multiple alkali metals;

K metal anode and KM₂O₄ cathode, where M can be:
any transition metal in isolation or combination of multiple transition metals,
Al in isolation or in combination of one or more transition metals, or
any alkali metal in isolation or combination of multiple alkali metals;

Na₄Ti₅O₁₂ anode and NaMO₂ or NaM₂O₄ cathode, where M can be:
any transition metal in isolation or combination of multiple transition metals,
Al in isolation or in combination of one or more transition metals, or
any alkali metal in isolation or combination of multiple alkali metals;

or

K₄Ti₅O₁₂ anode and KMO₂ or KM₂O₄ cathode, where M can be:
any transition metal in isolation or combination of multiple transition metals,
Al in isolation or in combination of one or more transition metals, or
any alkali metal in isolation or combination of multiple alkali metals.

### Example 40

A method of making an electrochemical device, whereby the method may comprise the following steps (in whole or in part, as well as substitutions, additions, and omissions thereof):

processing respective active material particles to sinter the pellets, intended to respectively be used for each of the cathode electrode and anode electrode;

configuring respective sintered pellets into a sintered cathode electrode and sintered anode electrode;

attaching a current collector (for cathode) to said sintered cathode electrode; applying the separator and adding the electrolyte to the sintered cathode electrode and separator;

attaching a current collector (for anode) to said sintered anode electrode;

adding the electrolyte to the sintered anode electrode; and

disposing a top cap or case in communication to the current collector (for anode) to provide a device in an assembled configuration.

### Example 41

The method of example 40, further comprising the following step: crimping or sealing the assembled device.

### Example 42

The method of example 41 (as well as subject matter in whole or in part of example 40), further comprising the following step:

electrochemically cycling the device as desired or required number of times.

### Example 43

The method of example 40 (as well as subject matter of one or more of any combination of examples 41-42, in whole or in part), wherein said sintered cathode electrode and said sintered anode electrode comprises any combination of at least one or more of the following:

Li metal anode and Li₄Ti₅O₁₂ cathode;

Li metal anode and LiN₂O₄ cathode,
where N can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiMO₂ cathode,
where M can be:
   any transition metal in isolation or combination of multiple transition metals,
   Al in isolation or in combination of one or more transition metals, or any alkali metal in isolation or combination of multiple alkali metals;

Li₄Ti₅O₁₂ anode and LiM₂O₄ cathode,
where M can be:
   any transition metal in isolation or combination of multiple transition metals, Al in isolation or in combination of one or more transition metals, or
   any alkali metal in isolation or combination of multiple alkali metals;

LiN₂O₄ anode and LiM₂O₄ cathode,
where N can be:
   any transition metal in isolation or combination of multiple transition metals,
   Al in isolation or in combination of one or more transition metals, or
   any alkali metal in isolation or combination of multiple alkali metals,
and
where M can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiNiₓMn_{y}Co_{z}O₂ cathode;
where x+y+z=1;

LiN₂O₄ anode and LiNiₓMn_{y}Co_{z}O₂ cathode;
where N can be:
   any transition metal in isolation or combination of multiple transition metals,
   Al in isolation or in combination of one or more transition metals,
   any alkali metal in isolation or combination of multiple alkali metals,
and
where x+y+z=1;

Li metal anode and LiMO₂ cathode, where M can be:
any transition metal in isolation or combination of multiple transition metals,
Al in isolation or in combination of one or more transition metals, or
any alkali metal in isolation or combination of multiple alkali metals;

or

Li metal anode and LiM₂O₄ cathode, where M can be:
any transition metal in isolation or combination of multiple transition metals,
Al in isolation or in combination of one or more transition metals, or
any alkali metal in isolation or combination of multiple alkali metals.

### Example 44

The method of example 40 (as well as subject matter of one or more of any combination of examples 42-43, in whole or in part), wherein said sintered cathode electrode and said sintered anode electrode comprises any combination of at least one or more of the following:

Na metal anode and Na₄Ti₅O₁₂ cathode;

K metal anode and K₄Ti₅O₁₂ cathode;

Na metal anode and NaMO₂ cathode, where M can be:
any transition metal in isolation or combination of multiple transition metals,
Al in isolation or in combination of one or more transition metals, or
any alkali metal in isolation or combination of multiple alkali metals;

K metal anode and KMO₂ cathode, where M can be:
any transition metal in isolation or combination of multiple transition metals,
Al in isolation or in combination of one or more transition metals, or
any alkali metal in isolation or combination of multiple alkali metals;

Na metal anode and NaM₂O₄ cathode, where M can be:
any transition metal in isolation or combination of multiple transition metals,
Al in isolation or in combination of one or more transition metals, or
any alkali metal in isolation or combination of multiple alkali metals;

K metal anode and KM₂O₄ cathode, where M can be:
any transition metal in isolation or combination of multiple transition metals,
Al in isolation or in combination of one or more transition metals, or
any alkali metal in isolation or combination of multiple alkali metals;

Na₄Ti₅O₁₂ anode and NaMO₂ or NaM₂O₄ cathode, where M can be:
any transition metal in isolation or combination of multiple transition metals,
Al in isolation or in combination of one or more transition metals, or
any alkali metal in isolation or combination of multiple alkali metals;

or

K₄Ti₅O₁₂ anode and KMO₂ or KM₂O₄ cathode, where M can be:
any transition metal in isolation or combination of multiple transition metals,
Al in isolation or in combination of one or more transition metals, or
any alkali metal in isolation or combination of multiple alkali metals.

### Example 45

An anode active material and a cathode active material for a Lithium ion battery, the anode active material and cathode active material being sintered and represented by at least one of the following compositional formulas:

Li metal anode and Li₄Ti₅O₁₂ cathode;

Li metal anode and LiN₂O₄ cathode,
where N can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiM02 cathode,
where M can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiM₂O₄ cathode,
where M can be:
   any transition metal in isolation or combination of multiple transition metals, Al in isolation or in combination of one or more transition metals, or
   any alkali metal in isolation or combination of multiple alkali metals;

LiN₂O₄ anode and LiM₂O₄ cathode,
where N can be:
   any transition metal in isolation or combination of multiple transition metals,
   Al in isolation or in combination of one or more transition metals, or
   any alkali metal in isolation or combination of multiple alkali metals,
and
where M can be:
   any transition metal in isolation or combination of multiple transition metals,
   Al in isolation or in combination of one or more transition metals, or
   any alkali metal in isolation or combination of multiple alkali metals;

Li₄Ti₅O₁₂ anode and LiNiₓMn_{y}Co_{z}O₂ cathode;
where x+y+z=1;

LiN₂O₄ anode and LiNiₓMn_{y}Co_{z}O₂ cathode;
where N can be:
   any transition metal in isolation or combination of multiple transition metals,
   Al in isolation or in combination of one or more transition metals,
   any alkali metal in isolation or combination of multiple alkali metals,
and
where x+y+z=1;

Li metal anode and LiMO₂ cathode, where M can be:
any transition metal in isolation or combination of multiple transition metals,
Al in isolation or in combination of one or more transition metals, or
any alkali metal in isolation or combination of multiple alkali metals;

or

Li metal anode and LiM₂O₄ cathode, where M can be:
any transition metal in isolation or combination of multiple transition metals,
Al in isolation or in combination of one or more transition metals, or
any alkali metal in isolation or combination of multiple alkali metals.

### Example 46

A lithium ion battery, comprising:

an anode and cathode including the sintered active material for a lithium ion battery according to example 45;

a separator; and

an electrolyte.

### Example 47

An anode active material and a cathode active material for a sodium or potassium ion battery, the anode active material and cathode active material being sintered and represented by at least one of the following compositional formulas:

Na metal anode and Na₄Ti₅O₁₂ cathode;

K metal anode and K₄Ti₅O₁₂ cathode;

Na metal anode and NaMO₂ cathode, where M can be:
any transition metal in isolation or combination of multiple transition metals,
Al in isolation or in combination of one or more transition metals, or
any alkali metal in isolation or combination of multiple alkali metals;

K metal anode and KMO₂ cathode, where M can be:
any transition metal in isolation or combination of multiple transition metals,
Al in isolation or in combination of one or more transition metals, or
any alkali metal in isolation or combination of multiple alkali metals;

Na metal anode and NaM₂O₄ cathode, where M can be:
any transition metal in isolation or combination of multiple transition metals,
Al in isolation or in combination of one or more transition metals, or
any alkali metal in isolation or combination of multiple alkali metals;

K metal anode and KM₂O₄ cathode, where M can be:
any transition metal in isolation or combination of multiple transition metals,
Al in isolation or in combination of one or more transition metals, or
any alkali metal in isolation or combination of multiple alkali metals;

Na₄Ti₅O₁₂ anode and NaMO₂ or NaM₂O₄ cathode, where M can be:
any transition metal in isolation or combination of multiple transition metals,
Al in isolation or in combination of one or more transition metals, or
any alkali metal in isolation or combination of multiple alkali metals;

or

K₄Ti₅O₁₂ anode and KMO₂ or KM₂O₄ cathode, where M can be:
any transition metal in isolation or combination of multiple transition metals,
Al in isolation or in combination of one or more transition metals, or
any alkali metal in isolation or combination of multiple alkali metals.

### Example 48

A sodium ion battery or potassium ion battery, comprising:

an anode and cathode including the sintered active material for a sodium or potassium ion battery according to example 47;

a separator; and

an electrolyte.

### Example 49

An electrochemical device comprising:

an anode electrode comprised of porous spaces and at least substantially sintered active material, in electronic communication with an anode current collector;

a cathode electrode comprised of porous spaces and at least substantially sintered active material, in electronic communication with a cathode current collector;

a separator comprised of channels, disposed between said anode electrode and said cathode electrode; and

an electrolyte in ionic contact with said anode electrode, said cathode electrode, and said separator, and which also fills said porous spaces within the anode electrode and cathode electrode.

### Example 50

The device of example 49, wherein said anode electrode comprises a coating.

### Example 51

The device of example 49 (as well as subject matter in whole or in part of example 49), wherein said cathode electrode comprises a coating.

### Example 52

The method of example 35 wherein the electrochemical device includes any of the characteristics, features or properties of the subject matter of one or more of any combination of examples 1-29 and 45-51, in whole or in part.

### Example 53

The method of example 40 wherein the electrochemical device includes any of the characteristics, features or properties of the subject matter of one or more of any combination of examples 1-29 and 45-51, in whole or in part.

### Example 54

The electrochemical device of example 45 or 46, wherein the electrochemical device includes any of the characteristics, features or properties of the subject matter of one or more of any combination of examples 1-29, in whole or in part.

### Example 55

The electrochemical device of example 47 or 48, wherein the electrochemical device includes any of the characteristics, features or properties of the subject matter of one or more of any combination of examples 1-29, in whole or in part.

### Example 56

The electrochemical device of example 49-51, wherein the electrochemical device includes any of the characteristics, features or properties of the subject matter of one or more of any combination of examples 1-29, in whole or in part.

### Example 57

The method of manufacturing any of the devices (structures or systems, or material) or their components or sub-components provided in any one or more of examples 1-29 and 45-51, in whole or in part.

### Example 58

The method of using any of the devices (structures or systems, or material) or their components or sub-components provided in any one or more of examples 1-29 and 45-51, in whole or in part.

### Example 59

Implementing any of the devices (structures or systems, or material) or their components or sub-components provided in any one or more of examples 1-29 and 45-51, in whole or in part with or as one of at least one of the following:

consumer electronics; wireless sensors; biomedical devices; medical instruments; power tools; electric vehicles; low temperature applications; high temperature applications;

unmanned aerial vehicles and crafts; unmanned land and water vehicles and crafts; satellites; drill heads; backup power; stationary energy storage; etc.;

for example, a coin cell architecture whereby it may be implemented for various small electronic device applications such as, but not limited thereto, computer motherboards; watches; wearable devices on humans; animals or other subjects; implantable medical devices; car keys; bicycle lights, etc.;

powerbank, such as for, but not limited thereto, charging smartphones, mobile tablet devices, and other USB charged devices, etc.; power supply for various USB powered (or other format powered) devices such as lights, small fans, electric appliances, or the like; powerbank may be a portable device that can supply power from its built-in batteries through a USB port (or other format port); and

“Internet of things” (IoT), which is a network of physical devices, vehicles, home appliances, and other items embedded with electronics, software, sensors, actuators, and connectivity which enables these things to connect, collect and exchange data.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

### REFERENCES

The following references and publications as listed below and throughout this document are hereby incorporated by reference in their entirety herein, and which are not admitted to be prior art with respect to the present invention by inclusion in this section.
1. Nitta N, Wu F, Lee J T, Yushin G (2015) Li-ion battery materials: Present and future. Mater Today 18:252-264. doi: 10.1016/j.mattod.2014.10.040
2. Andre D, Kim S-J, Lamp P, et al (2015) Future generations of cathode materials: an automotive industry perspective. J Mater Chem A 3:6709-6732. doi: 10.1039/C5TA00361J
3. Qi Z, Koenig GM (2017) Review Article: Flow battery systems with solid electroactive materials. J Vac Sci Technol B, Nanotechnol and Microelectron Mater Process Meas Phenom 35:40801. doi: 10.1116/1.4983210
4. Lai W, Erdonmez C K, Marinis T F, et al (2010) Ultrahigh-energy-density microbatteries enabled by new electrode architecture and micropackaging design. Adv. Mater. 22:139-144
5. Ning H, Pikul J H, Zhang R, et al (2015) Holographic patterning of high-performance on-chip 3D lithium-ion microbatteries. Proc Natl Acad Sci 112:6573-6578. doi: 10.1073/pnas.1423889112
6. Chen Z, Dahn J R (2002) Reducing Carbon in LiFePO[sub 4]/C Composite Electrodes to Maximize Specific Energy, Volumetric Energy, and Tap Density. J Electrochem Soc 149:A1184. doi: 10.1149/1.1498255
7. Chen J, Liu J, Qi Y, et al (2013) Unveiling the Roles of Binder in the Mechanical

Integrity of Electrodes for Lithium-Ion Batteries. J Electrochem Soc 160:A1502-A1509. doi: 10.1149/2.088309jes
8. Singh M, Kaiser J, Hahn H (2015) Thick Electrodes for High Energy Lithium Ion Batteries. J Electrochem Soc 162:A1196-A1201. doi: 10.1149/2.0401507jes
9. Kitada K, Murayama H, Fukuda K, et al (2016) Factors determining the packing-limitation of active materials in the composite electrode of lithium-ion batteries. J Power Sources 301:11-17. doi: 10.1016/j.jpowsour.2015.09.105
10. Wood D L, Li J, Daniel C (2015) Prospects for reducing the processing cost of lithium ion batteries. J Power Sources 275:234-242. doi: 10.1016/j.jpowsour.2014.11.019
11. Srinivasan V, Newman J (2004) Discharge Model for the Lithium Iron-Phosphate Electrode. J Electrochem Soc 151:A1517. doi: 10.1149/1.1785012
12. Chung D-W, Shearing P R, Brandon N P, et al (2014) Particle Size Polydispersity in Li-Ion Batteries. J Electrochem Soc 161:A422-A430. doi: 10.1149/2.097403jes
13. Zheng H, Li J, Song X, et al (2012) A comprehensive understanding of electrode thickness effects on the electrochemical performances of Li-ion battery cathodes. Electrochim Acta 71:258-265. doi: 10.1016/j.electacta.2012.03.161
14. Yang G-F, Song K-Y, Joo S-K (2015) Ultra-thick Li-ion battery electrodes using different cell size of metal foam current collectors. RSC Adv 5:16702-16706. doi: 10.1039/C4RA14485F
15. Wang K-X, Li X-H, Chen J-S (2015) Surface and Interface Engineering of Electrode Materials for Lithium-Ion Batteries. Adv Mater 27:527-545. doi: 10.1002/adma.201402962
16. Bae C J, Erdonmez C K, Halloran J W, Chiang Y M (2013) Design of battery electrodes with dual-scale porosity to minimize tortuosity and maximize performance. Adv Mater 25:1254-1258. doi: 10.1002/adma.201204055
17. Du Z, Wood D L, Daniel C, et al (2017) Understanding limiting factors in thick electrode performance as applied to high energy density Li-ion batteries. J Appl Electrochem 47:405-415. doi: 10.1007/s10800-017-1047-4
18. Marks T, Trussler S, Smith A J, et al (2011) A Guide to Li-Ion Coin-Cell Electrode Making for Academic Researchers. J Electrochem Soc 158:A51-A57. doi: 10.1149/1.3515072
19. Levasseur S, Menetrier M, Delmas C (2002) On the dual effect of Mg doping in LiCoO2 and Li1+delta CoO2: Structural, electronic properties, and Li-7 MAS NMR studies. Chem Mater 14:3584-3590. doi: 10.1021/cm021107j
20. Wood K N, Noked M, Dasgupta N P (2017) Lithium Metal Anodes: Toward an Improved Understanding of Coupled Morphological, Electrochemical, and Mechanical Behavior. ACS Energy Lett 2:664-672. doi: 10.1021/acsenergylett.6b00650
21. Ohzuku T, Ueda A, Yamamoto N (1995) Zero-Strain Insertion Material of Li Li1/3Ti5/3 O-4 for Rechargeable Lithium Cells. J Electrochem Soc 142:1431-1435. doi: 10.1149/1.2048592
22. Yang Z, Choi D, Kerisit S, et al (2009) Nanostructures and lithium electrochemical reactivity of lithium titanites and titanium oxides: A review. J Power Sources 192:588-598. doi: 10.1016/j.jpowsour.2009.02.038
23. Kim C, Norberg N S, Alexander C T, et al (2013) Mechanism of phase propagation during lithiation in carbon-free Li4Ti5O12 battery electrodes. Adv Funct Mater 23:1214-1222. doi: 10.1002/adfm.201201684
24. Song M-S, Benayad A, Choi Y-M, Park K-S (2012) Does Li₄Ti₅O₁₂ need carbon in lithium ion batteries? Carbon-free electrode with exceptionally high electrode capacity. Chem Commun 48:516-518. doi: 10.1039/C1CC16462G
25. Young D, Ransil A, Amin R, et al (2013) Electronic Conductivity in the Li_{4/3}Ti_{5/3}O₄-Li_{7/3} Ti_{5/3} O₄ System and Variation with State-of-Charge as a Li Battery Anode. Adv Energy Mater 3:1125-1129. doi: 10.1002/aenm.201300134
26. Singh M, Kaiser J, Hahn H (2015) Thick Electrodes for High Energy Lithium Ion Batteries. J Electrochem Soc 162:A1196-A1201. doi: 10.1149/2.0401507jes
27. (2017) Maxell
28. Qi Z, Koenig G M (2016) High-Performance LiCoO2 Sub-Micrometer Materials from Scalable Microparticle Template Processing. ChemistrySelect 1:3992-3999. doi: 10.1002/slct.201600872
29. Qi Z, Koenig G M (2016) A carbon-free lithium-ion solid dispersion redox couple with low viscosity for redox flow batteries. J Power Sources 323:97-106. doi: 10.1016/j.jpowsour.2016.05.033

The devices, systems, apparatuses, compositions, materials, machine readable medium, computer program products, and methods of various embodiments of the invention disclosed herein may utilize aspects disclosed in reference nos. 1-29.

### ADDITIONAL REFERENCES

The devices, systems, apparatuses, compositions, materials, computer program products, non-transitory computer readable medium, machine readable medium, and methods of various embodiments of the invention disclosed herein may utilize aspects disclosed in the following references, applications, publications and patents and which are hereby incorporated by reference herein in their entirety (and which are not admitted to be prior art with respect to the present invention by inclusion in this section):
A. U.S. Pat. Ser. No. 8,999,571 B2, Chiang, et al., “Batteries and Electrodes for use Thereof”, Apr. 7, 2015.
B. U.S. Pat. Ser. No. 9,620,824 B1, Andry, et al., “Micro Battery Design and Diagnosis”, Apr. 11, 2017.
C. J. Pierce Robinson, et al., “Sintered Electrode Full Cells for High Energy Density Lithium-Ion Batteries”, Journal of Applied Electrochemistry, https://doi.org/10.1007/s10800-018-1242-y, published online: 10 Aug. 2018.
D. J.Pierce Robinson, et al., Supplementary Material “Sintered Electrode Full Cells for High Energy Density Lithium-Ion Batteries”.
E. B. J. Neudecker, et al., “Lithium-Free” Thin-Film Battery with In Situ Plated Li Anode, Journal of The Electrochemical Society, 147 (2), 517-523 (2000), pages 517-523.
F. Nancy J. Dudney, “Thin Film Micro-Batteries—Building a Battery by Vapor Deposition”, The Electrochemical Society Interface, Fall 2008, pages 44-48.
G. Jos. F. M. Oudenhoven, et al., “All-Solid State Lithium-Ion Microbatteries” A Review of Various Three Dimensional Concepts”, Advanced Energy Materials, 2011, 1, pages 10-33.
H. International Patent Application Publication No. WO 2014/182535 A1, Lewis, J., et al., “Three-Dimensional (3D) Electrode Architecture for a Microbattery”, Nov. 13, 2014.
I. U.S. Pat. Ser. No.6,764,525 B1, Whitacre, J., et al., “Method for Manufacturing Thin-Film Lithium Microbatteries”, Jul. 20, 2004.1
J. U.S. Pat. Ser. No. 7,087,348 B2, Holman, R., et al., “Coated Electrode Particles for Composite Electrodes and Electrochemical Cells”, Aug. 8, 2006.
K. U.S. Pat. Ser. No. 6,783,894 B2, Kajiura, Y., et al., “Non-Aqueous Electrolyte Secondary Battery”, Aug. 31, 2004.
L. U.S. Pat. Ser. No. 6,679,926 B1, Kajiura, et al., “Lithium Secondary Cell and its Producing Method”, Jan. 20, 2004.
M. U.S. Pat. Ser. No. 9,299,966 B2, Chiang, et al., “High Energy High Power Electrodes and Batteries”, Mar. 29, 2016.
N. Japanese Patent No. JP 4196234 B2, Iguchi Takaai, et al., “A Non-Aqueous Electrolyte Lithium Secondary Battery”, Dec. 12, 2008.
O. Japanese Patent No. JP 2000285910 A, Kamimura Toshihiko, et al., “Lithium BatterY”, Oct. 13, 2000.
P. International Patent Application Publication No. WO 2018/0885522 A1, Yukihisa Takeuchi, et al.,“Secondary Battery”, Nov. 10, 2017.
Q. U.S. Pat. Ser. No. 8,168,326 B2, Chiang, et al., “Battery Structures, Self-Organizing Structures and Related Methods”, May 1, 2012.
R. U.S. Patent Application Publication No. US 2006/0102455 A1, Chiang, et al., “Electrochemical Methods, Devices, and Structures”, May 18, 2006.
S. International Patent Application Publication No. WO 2014/162532 A1, “All-Solid-State Battery, and Method for Producing All-Solid-State Battery”, Oct. 9, 2014.
T. Japanese Patent Application Publication No. JP 2018/125286 A, “Electrode Stack and all Solid Lithium Battery”, Aug. 9, 2018.
U. Robinson, J. Pierce, et al., “Sintered Electrode Full Cells for High Energy Density Lithium-Ion Batteries”, Aug. 6, 2018.
V. Robinson, J. Pierce, et al., “Exploring Electrode Architectures to Realize the True Potential of Lithium-ion Batteries”, Dec. 11, 2017; Abstract only.
W. U.S. Patent Application Publication No. US 2003/0082452 A1, Ueda, et al., “Lithium-Containing Composite Oxide and Nonaqueous Secondary Cell Using the Same, and Method for Manufacturing the Same”, May 1, 2003.
X. U.S. Patent Application Publication No. US 2011/0223487 A1, Johnson, et al., “Electrochemical Cell with Sintered Cathode and Both Solid and Liquid Electrolyte”, Sep. 15, 2011.

Y. U.S. Pat. Ser. No. 7,125,630 B2, Tanizaki, et al., “Non-Aqueous Electrolyte Battery”, Oct. 24, 2006.
Z. U.S. Pat. Ser. No. 6,051,340, Kawakami, et al., “Rechargeable Lithium Battery”, Apr. 18, 2000.
AA. U.S. Patent Application Publication No. US 2003/0008212 A1, Akashi, et al., “Anode Active Material and Nonaqueous Electrolyte Secondary Battery”, Jan. 9, 2003.
BB. Japanese Patent Application No. JP 2010/123423 A, Taku Kamimura, et al., “Positive Electrode for Nonaqueous Electrolyte Battery, and Nonaqueous Electrolyte Battery”, Jun. 3, 2010.
CC. Japanese Patent Application No. JP 2015/002091 A, Hiroshi Kitagawa, et al., “Positive Electrode Active Material for Lithium Ion Secondary Batteries, Lithium Ion Secondary Battery Positive Electrode Arranged by use thereof, Lithium Ion Secondary Battery, Lithium Ion Secondary Battery Module, and Method for Manufacturing Positive Electrode Active Material for Lithium Ion Secondary Batteries”, Jan. 5, 2015.
DD. European Patent Application Publication No. EP 3 113 262 A1, Lee, et al., “Lithium-Nickel Based Cathode Active Material, Method for Preparing Same, and Lithium Secondary Battery Including Same”, Jan. 4, 2017.
EE.U.S. Patent Application Publication No. US 2006/0141361 A1, Yuasa, et al., “Positive Electrode Material for Lithium Secondary Battery, Production Method Thereof, and Lithium Secondary Battery”, Jun. 29, 2006.
FF. International Patent Application Publication No. WO 2013/069502 A1, Yoshida, et al., “Lithium Secondary Battery and Method for Manufacturing Same”, May 16, 2013.
GG. U.S. Pat. Ser. No. 9,543,055 B2, Endo, et al., “Positive Active Material for Nonaqueous Electrolyte Secondary Battery, Method of Manufacturing the Positive Active Material, Electrode for Nonaqueous Electrolyte Secondary Battery, Nonaqueous Electrolyte Secondary Battery and Method of Manufacturing the Secondary Battery”, Jan. 10, 2017.
HH. International Patent Application Publication No. WO 2018/090956 A1, Guizhou, et al., “Positive Electrode Material for High Voltage Lithium Batter, Battery, Preparation Method Therefor and Use Thereof”, May 24, 2018.
II. International Patent Application Publication No. WO 2017/104688 A1, Endo, et al., “Positive Electrode Active Material for Lithium Secondary Batteries, Method for Manufacturing Precursor of Positive Electrode Active Material, Method for Manufacturing Positive Electrode Active Material, Positive Electrode for Lithium Secondary Batteries, and Lithium Secondary Battery”, Jun. 22, 2017.
JJ. Japanese Patent Application Publication No. JP 2000/331681 A, Taku Aoki, “Positive Electrode for Lithium Secondary Battery and Lithium Secondary Battery”, Nov. 30, 2000.
KK. Elango, R., et al., “Thick Binder-Free Electrodes for Li-Ion Battery Fabricated Using Templating Approach and Spark Plasma Sintering Reveals High Areal Capacity”, Advanced Energy Materials, 2018, No. 8, 1703031, pp 1-8.
LL.Ke, Xi, et al., “Improvement in Capacity Retention of Cathode Material for High Power Density Lithium Ion Batteries: The Route of Surface Coating”, Applied Energy, 194, 2017, pp 540-548.
MM. Chen, K., et al., “High Capacity and cyclic Performance in a Three-Dimensional Composite Electrode Filled with Inorganic Solid Electrolyte”, Journal of Power Sources”, 249, 2014, pp 306-310.
NN. Zhu, P., et al., “Utilizing Egg Lecithin Coating to Improve the Electrochemical Performance of Regenerated Lithium Iron Phosphate”, Journal of Alloys and Compounds, 745, 2018, pp 164-171.
OO. Liu, X., et al., “A new, High Energy Rechargeable Lithium Ion Battery with a Surface-Treated Li_{1.2}Mn_{0.54}Ni_{0.13}Co_{0.13}O₂ Cathode and a Nano-Structured Li₄Ti₅O₁₂ Anode”, Journal of Alloys and Compounds”, 648, 2015, pp 7-12.
PP. Aravindan, V., “Research Progress on Negative Electrodes for Practical Li-Ion Batteries: Beyond Carbonaceous Anodes”, Advanced Energy Materials, 2015, 5, 1402225, pp. 1-43.
QQ. Lai, W., et al., “Ultrahigh-Energy-Density Microbatteries Enabled by New Electrode Architecture and Micropackaging Design”, Advanced Energy Materials”, 2010, 22, E139-144.
RR. Yamada, H., et al., “Ideal Design of Textured LiCo₂ Sintered Electrode for Li-Ion Secondary Battery”, APL Materials 1, 2013, 043110, pp 1-5.
SS. Du, C., et al., “A Three Volt Lithium Ion Battery with LiCoPO₄ and Zero-Strain Li₄Ti₅O₁₂ as Insertion Material”, Electrochimica Acta, 125, 2014, pp-58-64.
TT.Cobb, E., et al., “Tortuosity of Binder-Free and Carbon-Free High Energy Density LiCoO₂ Electrodes for Rechargeable Lithium-Ion Batteries”, ECS Transactions, 58 (13), pp 13-24, 2014.
UU. Aliahmad, et al., “Poly(Vinylidene Fluoride-Helafluoropropylene) Polymer Electrolyte For Paper-Based and Flexible Battery Applications”, AIP Advances 6, 065206, pp 1-8, 2016.
VV. Chiang, Yet-Ming, “New Electrode Designs for Ultrahigh Energy Density”, MIT, May 11, 2011, pp 1-22.
WW. Kessels, E., et al., “Atomic Layer Deposition of Nanomaterials for Li-Ion Batteries, Fuel Cells, and Solar Cells”, https://www.sigmaaldrich.com/technical-documents/articles/materials-science/atomic/, pp 1-8, Oct. 22, 2018.
XX. Kayyar, A., et al., “Construction and Testing of Coin Cells of Lithium Ion Batteries”, Journal of Visualized Experiments, 2012, 66: 4014, Published Online 2012, Aug. 2, doi: 10.3791/4104, pp 1-7.
YY. Wang, R., et al., “Effect of Different Binders on the Electrochemical Performance of Metal Oxide Anode for Lithium-Ion Batteries”, Nanoscale Research Letters, 2017, 12:575, pp 1-11.
ZZ. Pierce, J. Robinson, “Tunable Coprecipitation of McnCO3 Templates for Synthesis of Li-ion Battery Materials, A Thesis Presented to the faculty of the School of Engineering and Applied Science University of Virginia, December 2015.
AAA. Stein, Malcolm, IV., et al., “Non-Aqueous Electrode Processing and Construction of Lithium-ion Coin Cells”, Journal of Visual Experiments”, 2016; (108), 53490, Published online 2016, Feb 1. Doi: 10.3791/53490, pp 1-15. yes
BBB. Chen, Jubin, “Mechanics of Electrode Materials in Lithium Battery Applications”, A Dissertation Submitted to the Faculty of the J.B. Speed School of Engineering of the University of Louisville, August 2015, pp 1-81. Yes, sort of.
CCC. U.S. Pat. Ser. No. 9,899,664 B2, Yamaki, et al., “Cathode Active Material for Lithium Ion Battery, Cathode Material for Lithium Ion Battery, and Lithium Ion Battery”, Feb. 20, 2018.

What is claimed is:

1. An electrochemical device comprising:
an anode electrode comprised of porous spaces and only sintered active material, in electronic communication with an anode current collector;
a cathode electrode comprised of porous spaces and only sintered active material, in electronic communication with a cathode current collector;
a separator comprised of channels, disposed between said anode electrode and said cathode electrode; and
an electrolyte in ionic contact with said anode electrode, said cathode electrode, and said separator, and which also fills said porous spaces within the anode electrode and cathode electrode.

2. The device of claim 1, further comprising:
an anode buffer structure disposed between said anode current collector and said anode electrode;
a cathode buffer structure disposed between said cathode current collector and said cathode electrode; or
an anode buffer structure disposed between said anode current collector and said anode electrode and a cathode buffer structure disposed between said cathode current collector and said cathode electrode.

3. The device of claim 2, wherein either said anode buffer structure or said cathode buffer structure or both of said anode buffer structure and said cathode buffer structure are comprised of a:
battery binder material;
conductive additive material; or
battery binder material and conductive material.

4. The device of claim 3, wherein said battery binder material is at least one of any combination of the following:
polyvinylidene difluoride (PVDF); styrene butadiene rubber (SBR), carboxymethyl cellulose (CMC), or polyacrylonitrile.

5. The device of claim 3, wherein said conductive additive material is at least one of any combination of the following: carbon black, graphite, carbon nanotubes, or graphene.

6. The device of claim 1, wherein said ionic contact includes said electrolyte dispersed within said channels of said separator.

7. The device of claim 1, wherein said separator itself provides ionic conductive contact if said separator is solid state electrolyte type or polymer electrolyte type.

8. The device of claim 1, wherein the thickness of said anode electrode is about 400 μm (i.e., about 4 mm).

9. The device of claim 1, wherein the thickness of said anode electrode is in the range of the following ranges:
about 100 μm to about 1,000 μm (i.e., between about 0.1 mm and about 1 mm);
about 150 μm to about 400 μm (i.e., between about 0.15 mm and about 0.4 mm);
about 250 μm to about 800 μm (i.e., between about 0.25 mm and about 0.8 mm);
about 270 μm to about 800 μm (i.e., between about 0.27 mm and about 0.8 mm);
about 350 μm to about 500 μm (i.e., between about 0.35 mm and about 0.5 mm);
about 300 μm to about 800 μm (i.e., between about 0.3 mm and about 0.8 mm);
about 350 μm to about 400 μm (i.e., between about 0.35 mm and about 0.4 mm);
about 400 μm to about 800 μm (i.e., between about 0.4 mm and about 0.8 mm);
about 450 μm to about 600 μm (i.e., between about 0.45 mm and about 0.6 mm);
about 500 μm to about 800 μm (i.e., between about 0.5 mm and about 0.8 mm);
about 800 μm to about 1,000 μm (i.e., between about 0.8 mm and about 1 mm);
about 200 μm to about 2,000 μm (i.e., between about 0.2 mm and about 2 mm);
about 250 μm to about 2,000 μm (i.e., between about 0.25 mm and about 2 mm);
about 270 μm to about 2,000 μm (i.e., between about 0.27 mm and about 2 mm);
about 300 μm to about 2,000 μm (i.e., between about 0.3 mm and about 2 mm);
about 1,000 μm to about 5,000 μm (i.e., between about 1 mm and about 5 mm);
about 1,000 μm to about 2,500 μm (i.e., between about 1 mm and about 2.5 mm);
about 2,500 μm to about 5,000 μm (i.e., between about 2.5 mm and about 5 mm);
about 4,000 μm to about 5,000 μm (i.e., between about 4 mm and about 5 mm); or
about 100 μm to about 5,000 μm (i.e., between about 0.1 mm and about 5 mm).

10. The device of claim 1, wherein the thickness of said cathode electrode is about 400 μm (i.e., about 4 mm).

11. The device of claim 1, wherein the thickness of said cathode electrode is in the range of the following ranges:
about 100 μm to about 1,000 μm (i.e., between about 0.1 mm and about 1 mm);
about 150 μm to about 400 μm (i.e., between about 0.15 mm and about 0.4 mm);
about 250 μm to about 800 μm (i.e., between about 0.25 mm and about 0.8 mm);
about 270 μm to about 800 μm (i.e., between about 0.27 mm and about 0.8 mm);
about 350 μm to about 500 μm (i.e., between about 0.35 mm and about 0.5 mm);
about 300 μm to about 800 μm (i.e., between about 0.3 mm and about 0.8 mm);
about 350 μm to about 400 μm (i.e., between about 0.35 mm and about 0.4 mm);
about 400 μm to about 800 μm (i.e., between about 0.4 mm and about 0.8 mm);
about 450 μm to about 600 μm (i.e., between about 0.45 mm and about 0.6 mm);
about 500 μm to about 800 μm (i.e., between about 0.5 mm and about 0.8 mm);
about 800 μm to about 1,000 μm (i.e., between about 0.8 mm and about 1 mm);
about 200 μm to about 2,000 μm (i.e., between about 0.2 mm and about 2 mm);
about 250 μm to about 2,000 μm (i.e., between about 0.25 mm and about 2 mm);
about 270 μm to about 2,000 μm (i.e., between about 0.27 mm and about 2 mm);
about 300 μm to about 2,000 μm (i.e., between about 0.3 mm and about 2 mm);
about 1,000 μm to about 5,000 μm (i.e., between about 1 mm and about 5 mm);
about 1,000 μm to about 2,500 μm (i.e., between about 1 mm and about 2.5 mm);
about 2,500 μm to about 5,000 μm (i.e., between about 2.5 mm and about 5 mm);
about 4,000 μm to about 5,000 μm (i.e., between about 4 mm and about 5 mm); or
about 100 μm to about 5,000 μm (i.e., between about 0.1 mm and about 5 mm).

12. The device of claim 1, wherein said anode current collector and/or said cathode current collector are in the shape of a frame or border.

13. The device of claim 1, wherein said respective active material of each said anode electrode and said cathode electrode comprises any combination of at least one or more of the following:
Li metal anode and Li₄Ti₅O₁₂ cathode;
Li metal anode and LiN₂O₄ cathode,
where N can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiMO₂ cathode,
where M can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiM₂O₄ cathode,
where M can be:
any transition metal in isolation or combination of multiple transition metals, Al in isolation or in combination of one or more transition metals, or
any alkali metal in isolation or combination of multiple alkali metals;
LiN₂O₄ anode and LiM₂O₄ cathode,
where N can be:
any transition metal in isolation or combination of multiple transition metals,
Al in isolation or in combination of one or more transition metals, or
any alkali metal in isolation or combination of multiple alkali metals,
and
where M can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiNiₓMn_{y}Co_{z}O₂ cathode;
where x+y+z=1;
LiN₂O₄ anode and LiNiₓMn_{y}Co_{z}O₂ cathode;
where N can be:
any transition metal in isolation or combination of multiple transition metals,
Al in isolation or in combination of one or more transition metals,
any alkali metal in isolation or combination of multiple alkali metals,
and
where x+y+z=1;
Li metal anode and LiMO₂ cathode, where M can be:
any transition metal in isolation or combination of multiple transition metals,
Al in isolation or in combination of one or more transition metals, or
any alkali metal in isolation or combination of multiple alkali metals;
or
Li metal anode and LiM₂O₄ cathode, where M can be:
any transition metal in isolation or combination of multiple transition metals,
Al in isolation or in combination of one or more transition metals, or
any alkali metal in isolation or combination of multiple alkali metals.

14. The device of claim 1, wherein said respective active material of each said anode electrode and said cathode electrode comprises any combination of at least one or more of the following:
Na metal anode and Na₄Ti₅O₁₂ cathode;
K metal anode and K₄Ti₅O₁₂ cathode;
Na metal anode and NaMO₂ cathode, where M can be:
any transition metal in isolation or combination of multiple transition metals,
Al in isolation or in combination of one or more transition metals, or
any alkali metal in isolation or combination of multiple alkali metals;
K metal anode and KMO₂ cathode, where M can be:
any transition metal in isolation or combination of multiple transition metals,
Al in isolation or in combination of one or more transition metals, or
any alkali metal in isolation or combination of multiple alkali metals;
Na metal anode and NaM₂O₄ cathode, where M can be:
any transition metal in isolation or combination of multiple transition metals,
Al in isolation or in combination of one or more transition metals, or
any alkali metal in isolation or combination of multiple alkali metals;
K metal anode and KM₂O₄ cathode, where M can be:
any transition metal in isolation or combination of multiple transition metals,
Al in isolation or in combination of one or more transition metals, or
any alkali metal in isolation or combination of multiple alkali metals;
Na₄Ti₅O₁₂ anode and NaMO₂ or NaM₂O₄ cathode, where M can be:
any transition metal in isolation or combination of multiple transition metals,
Al in isolation or in combination of one or more transition metals, or
any alkali metal in isolation or combination of multiple alkali metals;
or
K₄Ti₅O₁₂ anode and KMO₂ or KM₂O₄ cathode, where M can be:
any transition metal in isolation or combination of multiple transition metals,
Al in isolation or in combination of one or more transition metals, or
any alkali metal in isolation or combination of multiple alkali metals.

15. The device of claim 1, wherein:
said anode current collector is configured to be in communication with an external circuit;
said cathode current collector is configured to be in communication with an external circuit; or
said anode current collector is configured to be in communication with an external circuit and said cathode current collector is configured to be in communication with an external circuit.

16. The device of claim 1, wherein said anode electrode is free of: battery binder material, conductive additive material, or battery binder material and conductive additive material.

17. The device of claim 1, wherein said cathode electrode is free of: battery binder material, conductive additive material, or battery binder material and conductive additive material.

18. The device of claim 1, wherein said anode electrode is further configured with a coating disposed on the exterior so as to be an integrated, operable portion of said anode electrode.

19. The device of claim 1, wherein said cathode electrode is further configured with a coating disposed on the exterior so as to be an integrated, operable portion of said cathode electrode.

20. The device of claim 1, wherein said active material of said anode electrode is about 60 percent solid by volume fraction.

21. The device of claim 1, wherein said active material of said anode electrode is in the range of the following ranges:
about 35 percent solid by volume fraction to about 60 percent solid by volume fraction;
about 45 percent solid by volume fraction to about 70 percent solid by volume fraction;
about 60 percent solid by volume fraction to about 70 percent solid by volume fraction;
about 35 percent solid by volume fraction to about 80 percent solid by volume fraction;
about 65 percent solid by volume fraction to about 70 percent solid by volume fraction;
about 65 percent solid by volume fraction to about 75 percent solid by volume fraction;
about 70 percent solid by volume fraction to about 75 percent solid by volume fraction; or
about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 or 80 percent solid by volume fraction.

22. The device of claim 1, wherein said active material of said cathode electrode is about 60 percent solid by volume fraction.

23. The device of claim 1, wherein said active material of said cathode electrode is in the range of the following ranges:
about 35 percent solid by volume fraction to about 60 percent solid by volume fraction.
about 45 percent solid by volume fraction to about 70 percent solid by volume fraction;
about 60 percent solid by volume fraction to about 70 percent solid by volume fraction;
about 35 percent solid by volume fraction to about 80 percent solid by volume fraction;
about 65 percent solid by volume fraction to about 70 percent solid by volume fraction;
about 65 percent solid by volume fraction to about 75 percent solid by volume fraction;
about 70 percent solid by volume fraction to about 75 percent solid by volume fraction; or
about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 or 80 percent solid by volume fraction.

24. The device of claim 1, wherein said anode electrode and cathode electrode performs at one of the following:
electrode areal capacity of about 45 mAh/cm² and current density of about 1.28 mA/cm²;
electrode areal capacity of about 33 mAh/cm² and current density of about 2.56 mA/cm²;
electrode areal capacity of about 20 mAh/cm² and current density of about 6.4 mA/cm²; or
electrode areal capacity of about 8 mAh/cm² and current density of about 12.8 mA/cm².

25. The device of claim 1, wherein said anode electrode and cathode electrode performs at one of the following:
electrode areal capacity of about 18 mAh/cm² and current density of about 1.848 mA/cm²;
electrode areal capacity of about 16 mAh/cm² and current density of about 3.696 mA/cm²;
electrode areal capacity of about 12.5 mAh/cm² and current density of about 4.62 mA/cm²; or
electrode areal capacity of about 21.4 mAh/cm² and current density of about 0.462 mA/cm².

26. The device of claim 1, wherein said anode electrode and cathode electrode performs at electrode areal capacity at one of the following:
about 10 mAh/cm²;
about 15 mAh/cm²;
about 25 mAh/cm²;
about 35 mAh/cm²;
about 50 mAh/cm²;
about 65 mAh/cm²;
about 75 mAh/cm²;
about 80 mAh/cm²;
about 90 mAh/cm²; or
a range of about 10 mAh/cm² through about 90 mAh/cm².

27. The device of claim 1, wherein said anode electrode and cathode electrode performs at a current density at one of the following:
about 0.1 mA/cm²;
about 0.25 mA/cm²;
about 0.50 mA/cm²;
about 0.75 mA/cm²;
about 1.0 mA/cm²;
about 2.5 mA/cm²;
about 5.0 mA/cm²;
about 7.5 mA/cm²;
about 10.0 mA/cm²;
about 12.50 mA/cm²;
about 15.0 mA/cm²;
about 17.50 mA/cm²;
about 20.0 mA/cm²; or
a range of about 0.1 mA/cm² through about 20.0 mA/cm².

28. The device of claim 1, further comprising a cell casing configured to at least partially enclose said device.

29. The device of claim 1, wherein the device is provided in at least one of the following configurations:
button cell, coin cell, pouch cell, prismatic cell, flat cell, cylindrical cell, thin film cell, sealed cell, or wound cell.

30. A method of making an electrochemical device comprising the following steps:
synthesizing respective precursor materials, intended to respectively be used for each of a cathode electrode and an anode electrode, using coprecipitation technique;
mixing the respective synthesized precursor materials, intended to respectively be used for each of the cathode electrode and anode electrode, with lithium source and heating the mixture to provide active material particles;
milling the respective active material particles, intended to respectively be used for each of the cathode electrode and anode electrode;
coating the respective active material particles, intended to respectively be used for each of the cathode electrode and anode electrode, with a binder;
hydraulically pressing of the respective active particles into pellets, intended to respectively be used for each of the cathode electrode and anode electrode;
thermally treating the respective pellets to sinter the pellets, intended to respectively be used for each of the cathode electrode and anode electrode;
configuring respective sintered pellets into a sintered cathode electrode and sintered anode electrode;
applying electrically conductive buffer to a current collector (for cathode) and attach to said sintered cathode electrode;
applying the separator and adding the electrolyte to the sintered cathode electrode and separator;
applying electrically conductive buffer to a current collector (for anode) and attaching to said sintered anode electrode;
adding the electrolyte to the sintered anode electrode;
disposing a spring or compression component in communication with the sintered anode electrode; and
disposing a top cap or case in communication to the spring or compression component to provide a device in an assembled configuration;

31. The method of claim 30, further comprising the following step:
crimping or sealing the assembled device.

32. The method of claim 31, further comprising the following step:
electrochemically cycling the device a predetermined number of times.

33. The method of claim 31, wherein said sintered cathode electrode and said sintered anode electrode comprises any combination of at least one or more of the following:
Li metal anode and Li₄Ti₅O₁₂ cathode;
Li metal anode and LiN₂O₄ cathode,
where N can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiMO₂ cathode,
where M can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiM₂O₄ cathode,
where M can be:
any transition metal in isolation or combination of multiple transition metals, Al in isolation or in combination of one or more transition metals, or
any alkali metal in isolation or combination of multiple alkali metals;
LiN₂O₄ anode and LiM₂O₄ cathode,
where N can be:
any transition metal in isolation or combination of multiple transition metals,
Al in isolation or in combination of one or more transition metals, or
any alkali metal in isolation or combination of multiple alkali metals,
and
where M can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiNiₓMn_{y}Co_{z}O₂ cathode;
where x+y+z=1;
LiN₂O₄ anode and LiNiₓMn_{y}Co_{z}O₂ cathode;
where N can be:
any transition metal in isolation or combination of multiple transition metals,
Al in isolation or in combination of one or more transition metals,
any alkali metal in isolation or combination of multiple alkali metals,
and
where x+y+z=1;
Li metal anode and LiMO₂ cathode, where M can be:
any transition metal in isolation or combination of multiple transition metals,
Al in isolation or in combination of one or more transition metals, or
any alkali metal in isolation or combination of multiple alkali metals;
or
Li metal anode and LiM₂O₄ cathode, where M can be:
any transition metal in isolation or combination of multiple transition metals,
Al in isolation or in combination of one or more transition metals, or
any alkali metal in isolation or combination of multiple alkali metals.

34. The method of claim 31, wherein said sintered cathode electrode and said sintered anode electrode comprises any combination of at least one or more of the following:
Na metal anode and Na₄Ti₅O₁₂ cathode;
K metal anode and K₄Ti₅O₁₂ cathode;
Na metal anode and NaMO₂ cathode, where M can be:
any transition metal in isolation or combination of multiple transition metals,
Al in isolation or in combination of one or more transition metals, or
any alkali metal in isolation or combination of multiple alkali metals;
K metal anode and KMO₂ cathode, where M can be:
any transition metal in isolation or combination of multiple transition metals,
Al in isolation or in combination of one or more transition metals, or
any alkali metal in isolation or combination of multiple alkali metals;
Na metal anode and NaM₂O₄ cathode, where M can be:
any transition metal in isolation or combination of multiple transition metals,
Al in isolation or in combination of one or more transition metals, or
any alkali metal in isolation or combination of multiple alkali metals;
K metal anode and KM₂O₄ cathode, where M can be:
any transition metal in isolation or combination of multiple transition metals,
Al in isolation or in combination of one or more transition metals, or
any alkali metal in isolation or combination of multiple alkali metals;
Na₄Ti₅O₁₂ anode and NaMO₂ or NaM₂O₄ cathode, where M can be:
any transition metal in isolation or combination of multiple transition metals,
Al in isolation or in combination of one or more transition metals, or
any alkali metal in isolation or combination of multiple alkali metals;
or
K₄Ti₅O₁₂ anode and KMO₂ or KM₂O₄ cathode, where M can be:
any transition metal in isolation or combination of multiple transition metals,
Al in isolation or in combination of one or more transition metals, or
any alkali metal in isolation or combination of multiple alkali metals.

35. A method of making an electrochemical device comprising the following steps:
milling respective active material particles, intended to respectively be used for each of a cathode electrode and an anode electrode;
pressing of the respective active particles into pellets, intended to respectively be used for each of the cathode electrode and anode electrode;
thermally treating the respective pellets to sinter the pellets, intended to respectively be used for each of the cathode electrode and anode electrode;
configuring respective sintered pellets into a sintered cathode electrode and sintered anode electrode;
attaching a current collector (for cathode) to said sintered cathode electrode;
applying the separator and adding the electrolyte to the sintered cathode electrode and separator;
attaching a current collector (for anode) to said sintered anode electrode;
adding the electrolyte to the sintered anode electrode; and
disposing a top cap or case in communication to the current collector (for anode) to provide a device in an assembled configuration.

36. The method of claim 35, further comprising the following step:
crimping or sealing the assembled device.

37. The method of claim 36, further comprising the following step:
electrochemically cycling the device a predetermined number of times.

38. The method of claim 35, wherein said sintered cathode electrode and said sintered anode electrode comprises any combination of at least one or more of the following:
Li metal anode and Li₄Ti₅O₁₂ cathode;
Li metal anode and LiN₂O₄ cathode,
where N can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiMO₂ cathode,
where M can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiM₂O₄ cathode,
where M can be:
any transition metal in isolation or combination of multiple transition metals, Al in isolation or in combination of one or more transition metals, or
any alkali metal in isolation or combination of multiple alkali metals;
LiN₂O₄ anode and LiM₂O₄ cathode,
where N can be:
any transition metal in isolation or combination of multiple transition metals,
Al in isolation or in combination of one or more transition metals, or
any alkali metal in isolation or combination of multiple alkali metals,
and
where M can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiNiₓMn_{y}Co_{z}O₂ cathode;
where x+y+z=1;
LiN₂O₄ anode and LiNiₓMn_{y}Co_{z}O₂ cathode;
where N can be:
any transition metal in isolation or combination of multiple transition metals,
Al in isolation or in combination of one or more transition metals,
any alkali metal in isolation or combination of multiple alkali metals,
and
where x+y+z=1;
Li metal anode and LiMO₂ cathode, where M can be:
any transition metal in isolation or combination of multiple transition metals,
Al in isolation or in combination of one or more transition metals, or
any alkali metal in isolation or combination of multiple alkali metals;
or
Li metal anode and LiM₂O₄ cathode, where M can be:
any transition metal in isolation or combination of multiple transition metals,
Al in isolation or in combination of one or more transition metals, or
any alkali metal in isolation or combination of multiple alkali metals.

39. The method of claim 35, wherein said sintered cathode electrode and said sintered anode electrode comprises any combination of at least one or more of the following:
Na metal anode and Na₄Ti₅O₁₂ cathode;
K metal anode and K₄Ti₅O₁₂ cathode;
Na metal anode and NaMO₂ cathode, where M can be:
any transition metal in isolation or combination of multiple transition metals,
Al in isolation or in combination of one or more transition metals, or
any alkali metal in isolation or combination of multiple alkali metals;
K metal anode and KMO₂ cathode, where M can be:
any transition metal in isolation or combination of multiple transition metals,
Al in isolation or in combination of one or more transition metals, or
any alkali metal in isolation or combination of multiple alkali metals;
Na metal anode and NaM₂O₄ cathode, where M can be:
any transition metal in isolation or combination of multiple transition metals,
Al in isolation or in combination of one or more transition metals, or
any alkali metal in isolation or combination of multiple alkali metals;
K metal anode and KM₂O₄ cathode, where M can be:
any transition metal in isolation or combination of multiple transition metals,
Al in isolation or in combination of one or more transition metals, or
any alkali metal in isolation or combination of multiple alkali metals;
Na₄Ti₅O₁₂ anode and NaMO₂ or NaM₂O₄ cathode, where M can be:
any transition metal in isolation or combination of multiple transition metals,
Al in isolation or in combination of one or more transition metals, or
any alkali metal in isolation or combination of multiple alkali metals;
or
K₄Ti₅O₁₂ anode and KMO₂ or KM₂O₄ cathode, where M can be:
any transition metal in isolation or combination of multiple transition metals,
Al in isolation or in combination of one or more transition metals, or
any alkali metal in isolation or combination of multiple alkali metals.

40. A method of making an electrochemical device comprising the following steps:
processing respective active material particles to sinter the pellets, intended to respectively be used for each of the cathode electrode and anode electrode;
configuring respective sintered pellets into a sintered cathode electrode and sintered anode electrode;
attaching a current collector (for cathode) to said sintered cathode electrode;
applying the separator and adding the electrolyte to the sintered cathode electrode and separator;
attaching a current collector (for anode) to said sintered anode electrode;
adding the electrolyte to the sintered anode electrode; and
disposing a top cap or case in communication to the current collector (for anode) to provide a device in an assembled configuration.

41. The method of claim 40, further comprising the following step:
crimping or sealing the assembled device.

42. The method of claim 41, further comprising the following step:
electrochemically cycling the device as desired or required number of times.

43. The method of claim 40, wherein said sintered cathode electrode and said sintered anode electrode comprises any combination of at least one or more of the following:
Li metal anode and Li₄Ti₅O₁₂ cathode;
Li metal anode and LiN₂O₄ cathode,
where N can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiMO₂ cathode,
where M can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiM₂O₄ cathode,
where M can be:
any transition metal in isolation or combination of multiple transition metals, Al in isolation or in combination of one or more transition metals, or
any alkali metal in isolation or combination of multiple alkali metals;
LiN₂O₄ anode and LiM₂O₄ cathode,
where N can be:
any transition metal in isolation or combination of multiple transition metals,
Al in isolation or in combination of one or more transition metals, or
any alkali metal in isolation or combination of multiple alkali metals,
and
where M can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiNiₓMn_{y}Co_{z}O₂ cathode;
where x+y+z=1;
LiN₂O₄ anode and LiNiₓMn_{y}Co_{z}O₂ cathode;
where N can be:
any transition metal in isolation or combination of multiple transition metals,
Al in isolation or in combination of one or more transition metals,
any alkali metal in isolation or combination of multiple alkali metals,
and
where x+y+z=1;
Li metal anode and LiMO₂ cathode, where M can be:
any transition metal in isolation or combination of multiple transition metals,
Al in isolation or in combination of one or more transition metals, or
any alkali metal in isolation or combination of multiple alkali metals;
or
Li metal anode and LiM₂O₄ cathode, where M can be:
any transition metal in isolation or combination of multiple transition metals,
Al in isolation or in combination of one or more transition metals, or
any alkali metal in isolation or combination of multiple alkali metals.

44. The method of claim 40, wherein said sintered cathode electrode and said sintered anode electrode comprises any combination of at least one or more of the following:
Na metal anode and Na₄Ti₅O₁₂ cathode;
K metal anode and K₄Ti₅O₁₂ cathode;
Na metal anode and NaMO₂ cathode, where M can be:
any transition metal in isolation or combination of multiple transition metals,
Al in isolation or in combination of one or more transition metals, or
any alkali metal in isolation or combination of multiple alkali metals;
K metal anode and KMO₂ cathode, where M can be:
any transition metal in isolation or combination of multiple transition metals,
Al in isolation or in combination of one or more transition metals, or
any alkali metal in isolation or combination of multiple alkali metals;
Na metal anode and NaM₂O₄ cathode, where M can be:
any transition metal in isolation or combination of multiple transition metals,
Al in isolation or in combination of one or more transition metals, or
any alkali metal in isolation or combination of multiple alkali metals;
K metal anode and KM₂O₄ cathode, where M can be:
any transition metal in isolation or combination of multiple transition metals,
Al in isolation or in combination of one or more transition metals, or
any alkali metal in isolation or combination of multiple alkali metals;
Na₄Ti₅O₁₂ anode and NaMO₂ or NaM₂O₄ cathode, where M can be:
any transition metal in isolation or combination of multiple transition metals,
Al in isolation or in combination of one or more transition metals, or
any alkali metal in isolation or combination of multiple alkali metals;
or
K₄Ti₅O₁₂ anode and KMO₂ or KM₂O₄ cathode, where M can be:
any transition metal in isolation or combination of multiple transition metals,
Al in isolation or in combination of one or more transition metals, or
any alkali metal in isolation or combination of multiple alkali metals.

45. An anode active material and a cathode active material for a Lithium ion battery, the anode active material and cathode active material being sintered and represented by at least one of the following compositional formulas:
Li metal anode and Li₄Ti₅O₁₂ cathode;
Li metal anode and LiN₂O₄ cathode,
where N can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiM02 cathode,
where M can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiM204 cathode,
where M can be:
any transition metal in isolation or combination of multiple transition metals, Al in isolation or in combination of one or more transition metals, or
any alkali metal in isolation or combination of multiple alkali metals;
LiN₂O₄ anode and LiM₂O₄ cathode,
where N can be:
any transition metal in isolation or combination of multiple transition metals,
Al in isolation or in combination of one or more transition metals, or
any alkali metal in isolation or combination of multiple alkali metals,
and
where M can be:
any transition metal in isolation or combination of multiple transition metals,
Al in isolation or in combination of one or more transition metals, or
any alkali metal in isolation or combination of multiple alkali metals;
Li₄Ti₅O₁₂ anode and LiNiₓMn_{y}Co_{z}O₂ cathode;
where x+y+z=1;
LiN₂O₄ anode and LiNiₓMn_{y}Co_{z}O₂ cathode;
where N can be:
any transition metal in isolation or combination of multiple transition metals,
Al in isolation or in combination of one or more transition metals,
any alkali metal in isolation or combination of multiple alkali metals,
and
where x+y+z=1;
Li metal anode and LiMO₂ cathode, where M can be:
any transition metal in isolation or combination of multiple transition metals,
Al in isolation or in combination of one or more transition metals, or
any alkali metal in isolation or combination of multiple alkali metals;
or
Li metal anode and LiM₂O₄ cathode, where M can be:
any transition metal in isolation or combination of multiple transition metals,
Al in isolation or in combination of one or more transition metals, or
any alkali metal in isolation or combination of multiple alkali metals.

46. A lithium ion battery, comprising:
an anode and cathode including the sintered active material for a lithium ion battery according to claim 45;
a separator; and
an electrolyte.

47. An anode active material and a cathode active material for a sodium or potassium ion battery, the anode active material and cathode active material being sintered and represented by at least one of the following compositional formulas:
Na metal anode and Na₄Ti₅O₁₂ cathode;
K metal anode and K₄Ti₅O₁₂ cathode;
Na metal anode and NaMO₂ cathode, where M can be:
any transition metal in isolation or combination of multiple transition metals,
Al in isolation or in combination of one or more transition metals, or
any alkali metal in isolation or combination of multiple alkali metals;
K metal anode and KMO₂ cathode, where M can be:
any transition metal in isolation or combination of multiple transition metals,
Al in isolation or in combination of one or more transition metals, or
any alkali metal in isolation or combination of multiple alkali metals;
Na metal anode and NaM₂O₄ cathode, where M can be:
any transition metal in isolation or combination of multiple transition metals,
Al in isolation or in combination of one or more transition metals, or
any alkali metal in isolation or combination of multiple alkali metals;
K metal anode and KM₂O₄ cathode, where M can be:
any transition metal in isolation or combination of multiple transition metals,
Al in isolation or in combination of one or more transition metals, or
any alkali metal in isolation or combination of multiple alkali metals;
Na₄Ti₅O₁₂ anode and NaMO₂ or NaM₂O₄ cathode, where M can be:
any transition metal in isolation or combination of multiple transition metals,
Al in isolation or in combination of one or more transition metals, or
any alkali metal in isolation or combination of multiple alkali metals;
or
K₄Ti₅O₁₂ anode and KMO₂ or KM₂O₄ cathode, where M can be:
any transition metal in isolation or combination of multiple transition metals,
Al in isolation or in combination of one or more transition metals, or
any alkali metal in isolation or combination of multiple alkali metals.

48. A sodium ion battery or potassium ion battery, comprising:
an anode and cathode including the sintered active material for a sodium or potassium ion battery according to claim 47;
a separator; and
an electrolyte.

49. An electrochemical device comprising:
an anode electrode comprised of porous spaces and at least substantially sintered active material, in electronic communication with an anode current collector;
a cathode electrode comprised of porous spaces and at least substantially sintered active material, in electronic communication with a cathode current collector;
a separator comprised of channels, disposed between said anode electrode and said cathode electrode; and
an electrolyte in ionic contact with said anode electrode, said cathode electrode, and said separator, and which also fills said porous spaces within the anode electrode and cathode electrode.

50. The device of claim 49, wherein said anode electrode comprises a coating.

51. The device of claim 49, wherein said cathode electrode comprises a coating.
